(19) United States
(12) Patent Application Publication
(10) Pub. No.: US 2022/0196000 A1
(43) Pub. Date: Jun. 23, 2022

(54) COMPENSATION OF FLOW VARIATIONS OF A PISTON PUMP AND CONSTANT-RATE AUTOMATED PLACEMENT OF CONCRETE

(71) Applicant: Michael George BUTLER, Fort Bragg, CA (US)

(72) Inventor: Michael George BUTLER, Fort Bragg, CA (US)

(21) Appl. No.: 17/601,888

(22) PCT Filed: Apr. 6, 2020
(86) PCT No.: PCT/US2020/026952

§ 371 Date: Oct. 6, 2021

Related U.S. Application Data
(60) Provisional application No. 62/830,445, filed on Apr. 6, 2019.
(60) Provisional application No. 62/834,923, filed on Apr. 16, 2019.

(51) Int. Cl. F04B 9/107; F04B 15/02; F04B 49/06; E04G 21/04; E04G 21/06; E04B 1/16; E04B 1/35; E04G 11/24; E02D 29/02; B28C 5/02; B28C 5/08

(52) U.S. Cl. CPC F04B 9/1076; F04B 15/02; F04B 49/065; E04G 21/0427; E04G 21/065; E04B 1/16; E02D 2300/002; E04G 11/24; E02D 29/0283; B28C 5/026; B28C 5/08; E02D 2250/0023; E04B 1/3505

(57) ABSTRACT

A device that compensates for abrupt variations in fluid flow rate for a pump line is described. One or more aspects pertain to a system to accomplish automated in-situ placement of a concrete wall or embankment, where a fluid concrete is pumped into place, consolidated, and screeded to a finished surface, with remotely controlled or automated equipment.

### CROSS-REFERENCE TO RELATED APPLICATIONS

The present application claims benefit of U.S. Patent Application Ser. No. 62/830,445, entitled “APPARATI TO COMPENSATE FLOW VARIATIONS OF A PISTON PUMP, PARTICULARLY ALLOWING CONSTANT-RATE ROBOTIC PLACEMENT OF CONCRETE,” to Michael George BUTLER, filed Apr. 6, 2019 and claims benefit of U.S. Patent Application Ser. No. 62/834,923, entitled “VERY RAPID CONCRETE SLIP FORMING OVER EXTENSIVE VERTICAL SURFACES WITH REMOTELY CONTROLLED AND AUTOMATED SYSTEMS,” to Michael George BUTLER, filed Apr. 16, 2019. The present application is related to U.S. Patent Application Ser. No. 62/446,443, titled “Method and System using a Volumetric Concrete Mixer to Make Zero-Slump-Pumpable Concrete,” to Michael George BUTLER, filed Jan. 15, 2017 and U.S. Patent Application Ser. No. 62/446,444, titled “Methods and Devices to Make Zero-Slump-Pumpable Concrete,” to Michael George BUTLER, filed Jan. 15, 2017 and “APPARATI AND SYSTEMS FOR AND METHODS OF GENERATING AND PLACING ZERO-SLUMP-PUMPABLE CONCRETE”, to Michael George BUTLER, filed Jan. 16, 2018; and U.S. Patent Application Ser. No. 62/793,868, titled “ADDITIVE LAYERING SYSTEMS FOR CAST-CONCRETE WALLS” to Michael George BUTLER, filed Jan. 17, 2019; and U.S. Patent Application Ser. No. 62/830,445, titled “APPARATI TO COMPENSATE FLOW VARIATIONS OF A PISTON PUMP, PARTICULARLY ALLOWING CONSTANT RATE ROBOTIC PLACEMENT OF CONCRETE” to Michael George BUTLER, filed Apr. 6, 2019; and U.S. Patent Application Ser. No. 62/834,923 “VERY RAPID CONCRETE SLIP FORMING OVER EXTENSIVE VERTICAL SURFACES WITH REMOTELY CONTROLLED AND AUTOMATED SYSTEMS” to Michael George BUTLER, filed Apr. 16, 2019; and PCT Application PCT/US2020/014215, titled “ADDITIVE LAYERING SYSTEMS FOR CAST-CONCRETE WALLS” to Michael George BUTLER, filed Jan. 17, 2020. The contents of all of these applications and patents are incorporated herein in their entirety by this reference for all purposes.

### BACKGROUND

One or more aspects of the present invention pertain to the technical field of construction. More particularly, one or more aspects of the present invention pertain to the field of structural concrete cast in-situ for walls and such. More particularly the present invention pertains to controlling abrupt cyclical flow fluctuations typical of piston concrete pumps, to that of a continuous flow; benefitting extended boom placement of concrete, and allowing automated concrete placement with use of a piston pump. The present invention also discloses systems for very rapid slip forming of concrete over extensive vertical surfaces by remote or automated means.

SUMMARY

One aspect of the present invention is a system that includes a concrete pump line fitted with a device that compensates for variations in flow rate such as that is generally attributed to a piston pumping sequence, where a swing-tube pumping system abruptly interrupts flow between strokes of the pistons in each of two cylinders. Another aspect of the invention is an independent apparatus that compensates for variations in flow rate such that is generally attributed to a piston pumping sequence. Active, passive, and combined variations of these device are disclosed. Another aspect of the present invention is a system that automatically controls the placement of concrete for walls and embankments.

It is to be understood that the invention is not limited in its application to the details of construction and to the arrangements of the components set forth in the following description. The invention is capable of other embodiments and of being practiced and carried out in various ways. In addition, it is to be understood that the phraseology and terminology employed herein are for the purpose of description and should not be regarded as limiting.

### BRIEF DESCRIPTION OF THE DRAWINGS

FIG. 1 is a side section view of one embodiment of the present invention during a period of normal concrete flow.

FIG. 2 is a side section view of one embodiment of the present invention having discharged withheld concrete.

FIG. 3 is a partial side section view of one embodiment of the present invention showing more detail of the features.

FIG. 4 is a partial side exterior view of one embodiment of the present invention showing use of traditional shock absorbers.

FIG. 5 is a section view of one embodiment of the present invention showing options for clean out.

FIG. 6 is a partial side section view of one embodiment of the present invention showing a variation for air assist.

FIG. 7 is a section and top view of an aligning device for multiple springs.

FIG. 8 is a side view of one embodiment of the present invention showing use with a conventional “coil-over” shock absorber.

FIG. 9 is a section view of one embodiment of the present invention showing the spring and support.

FIG. 10 is a side section view of an embodiment having sensor systems for hydraulic control of the compensator mechanics and design modifications allowing a larger compensation capacity.

FIG. 11 is a top view of the embodiment of the present invention shown in FIG. 10.

FIG. 12 is a partial section view of the embodiment of the present invention shown in FIG. 10.

FIG. 13 shows graphs of a typical swing-tube pumping cycle and a preferred corresponding response provided by the compensation device.

FIG. 14 shows an embodiment of the present invention utilized in a concrete pumping operation.

FIG. 15 is another embodiment showing a preferred path for the compensating concrete.

FIG. 16 shows a side section view of an air-assisted embodiment of the present invention during a period of normal concrete flow.

FIG. 17 shows a side section view of an air-assisted embodiment of the present invention during the discharge of withheld concrete.

FIG. 18 shows a side section view of a hydraulic-assisted embodiment of the present invention during a period of normal concrete flow.

FIG. 19 shows a side section view of a hydraulic-assisted embodiment of the present invention during the discharge of withheld concrete.

FIG. 20A shows a side section view of a hydraulic-assisted embodiment of the present invention using sensors on the concrete pump for controlling discharge of withheld concrete.

FIG. 20B shows a side section view of a hydraulic-assisted embodiment of the present invention using sensors on the concrete pump for controlling compensation.

FIG. 21 shows a side section view of a motor-drive assisted withdrawal of concrete.

FIG. 22 shows a top section view of a motor-drive assisted withdrawal of concrete.

FIG. 23 shows an end section view of a motor-drive assisted withdrawal of concrete.

FIG. 24 shows detail of this embodiment of the drive pulley support.

FIG. 25A shows an end view of a pinch drive assisted withdrawal of concrete.

FIG. 25B shows a side view of a pinch drive assisted withdrawal of concrete.

FIG. 26 shows an embodiment utilizing compressed air to compensate pulsations.

FIG. 27 shows an embodiment where the compensator attaches to an inline mixer.

FIG. 28A shows a compensation system onboard a concrete pumping boom truck.

FIG. 28B shows another variation of a compensation system on a pumping boom truck.

FIG. 28C shows a compensation device with electromagnet control.

FIG. 29 is an overview of a large-scale slip-screeding operation

FIG. 30 is a side view of a control platform.

FIG. 31 is a side view of a concrete hose lift system.

FIG. 32 is side-section of a slip-screed and controlled concrete placement system.

FIG. 33 is a face view of a slip-screed and controlled concrete placement system.

FIG. 34 is a side-section of a slip-screed showing a guide truss.

FIG. 35 is a section of a truss chord at a sliding locator.

FIG. 36 is a side-section of a tube slip-screed showing a guide truss.

FIG. 37 is a side-section of a tube slip-screed showing a placement device.

FIG. 38 is a face view of a tube slip-screed with a truss and placement device.

FIG. 39 shows a stabilization means for a guide truss bottom end.

FIG. 40 shows a schematic layout for a pressure-controlled motion system.

FIG. 41 is a logic sequence chart for control of a concrete placement system.

FIG. 42 is a logic sequence chart for control of concrete vibration.

FIG. 43 is a logic sequence chart for starting a new pass of concrete placement.

FIG. 44 shows a liquid distribution system for a non-stick-surface system.

FIG. 45 is a section view of a geometry-defining non-stick-surface system.

FIG. 46 is an isometric view of a geometry-defining non-stick-surface system.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DESCRIPTION

For the following defined terms, these definitions shall be applied, unless a different definition is given in the claims or elsewhere in this specification. All numeric values are herein defined as being modified by the term “about,” whether or not explicitly indicated. The term “about” generally refers to a range of numbers that a person of ordinary skill in the art would consider equivalent to the stated value to produce substantially the same properties, function, result, etc. A numerical range indicated by a low value and a high value is defined to include all numbers subsumed within the numerical range and all subranges subsumed within the numerical range. As an example, the range 10 to 15 includes, but is not limited to, 10, 10.1, 10.47, 11, 11.75 to 12.2, 12.5, 13 to 13.8, 14, 14.025, and 15.

Various embodiments of the present invention may include any of the described features, alone or in combination. Other features and/or benefits of this disclosure will be apparent from the following description. Furthermore, the following description is primarily directed towards pumping fluids such as fluid concrete. It is to be understood that aspects and embodiments of the present invention may be applied to the pumping of fluids other than fluid concrete. Such fluids other than fluid concrete may be apparent to persons of ordinary skill in the art in view of the present disclosure.

The order of execution or performance of the operations or the processes in embodiments of the invention illustrated and described herein is not essential, unless otherwise specified. That is, the operations or the processes may be performed in any order, unless otherwise specified, and embodiments of the invention may include additional or fewer operations or processes than those disclosed herein. For example, it is contemplated that executing or performing a particular operation or process before, simultaneously with, contemporaneously with, or after another operation or process is within the scope of aspects of the invention.

The following patents are hereby incorporated by reference herein, in their entirety, for all purposes: U.S. Pat. Nos. 9,061,940, 9,266,969, 9,260,734, 9,238,591, 9,802,864, 9,643,888, 9,416,051, 9,266,969, 9,056,932, 8,882,907, 7,294,194, 5,753,036, 4,654,085, 8,864,905, 8,828,137, 8,764,273, 8,648,120, 8,491,717, 8,268,927, 6,221,152, 5,175,277, 9,505,658, 9,574,076, 9,199,881, 8,430,957, 8,545,620, 8,349,960, 9,040,609, 9,181,130. These patents disclose information about various agents that modify concrete rheology to impart properties of thixotropy, where the at-rest shear strength is sufficient to allow vertical stacking of the concrete, with a shear thinning, allowing pumping and manipulation of the zero-slump mix.

The various elements of any of these devices disclosed herein can advantageously be combined with other devices in many different permutations. Generally, for the present disclosure, only a single example of each feature is given, and any of the other combinations of the features is not also shown, as it is typically apparent that these other combinations of the features can be made by persons of ordinary skill in the art in view of the present specification.

One or more embodiments of the present invention pertain to controlling variations in concrete pump rate, in particular the abrupt cyclical interruption of flow rate created by the pause in pumping that occurs where a piston pump system switches cylinders. With a swing tube pump, the pause is to allow the discharge tube to swing over to the other cylinder that is ready for discharge; this is similar for other switchover mechanisms such as that of the “Rock” valve system designed by Schwing concrete pumps, etc. These types of switching-cylinder piston pumps are much preferred, in that they do not require a fluid valve system that limit the size of aggregate that can be pumped. The concrete mix required for additive-manufacturing, very rapid slip-forming, or for shotcrete processes, etc is necessarily of a low slump, and any type of a concrete mix having more resistance to pumping, tends to accentuate the abrupt pressure variations created by a piston pump cycle, and these applications cannot reasonably be automated without eliminating or at least minimizing the pumping surges. For this reason, the pumps utilized for these purposes tend to be screw or progressive-cavity, or valve-action pumps, which have several disadvantages with regard to pumping concrete: They do not allow passage of large aggregates, they pump much more slowly, and they have expensive wear parts that tend to wear out more quickly. These are some of the reasons that switching-cylinder piston pumps have dominated the concrete pumping market worldwide over the last few decades. It is far preferable to be able to utilize one of the thousands of these pumps now in service, for new purposes of automated placement of concrete, which is what the various embodiments of the present invention will allow.

The pump flow variations, known as pulsations, cause a problem particular to shotcrete where a liquid accelerator is injected into the concrete flow near the spray nozzle. As the accelerator is injected at a constant rate, but the concrete flow is fluctuating, the proportion of accelerator changes according to those variations. During the periods of interruption in concrete flow, the proportion of accelerator becomes much too high, weakening the hardened concrete in that layer. In forensic analysis the shotcrete can show distinct layers having too much accelerator, and so are distinct layers of weakness within the material. Various embodiments of the present invention solve this problem.

Where concrete is pumped and transported overhead through pipes with an actuated boom, known as a boom pump, the concrete pump pulsations transmit vibrations into the boom system. This can cause severe vibrational problems, especially at maximum extension where the boom is most susceptible to oscillation. Complex and expensive vibrational cancellation systems are devised and employed to counteract this problem, with mixed results. One or more embodiments of the present invention also solves this problem, and will allow such a conventional articulated boom to follow a smooth and consistent enough path of travel to be used as a numerically controlled device for placing concrete.

To convert a cyclically-interrupted flow into a continuous flow rate, so that a conventional piston concrete pump can be utilized for applications such as numerically-controlled additive-manufacturing—also known as 3D printing, or any type of automated placement means, improvements to the existing surge control device technology are required. A primary reason for this is that existing “surge control” devices cannot expel enough concrete rapidly enough to sufficiently fill the gap between pump strokes, and so are often not even bothered with, as the surge effects are not sufficiently mitigated. Embodiments of the presently disclosed devices have a geometry that allows a rapid discharge of compensating concrete, and can have both passive and active control systems to truly compensate the cyclical fluctuations of a concrete pump, minimizing surge effects; and they can create a consistent enough rate of net flow output, so that automated placement methods are made practical with use of a typical piston concrete pump.

The ideal functioning of this device is one where during normal pumping pressure, concrete is absorbed into the compensator at a rate low enough so that the downstream flow rate is lowered to an average rate, and at the moment where the concrete pump switches cylinders between pump strokes—where the pumping pressure is momentarily effectively zero—the compensator then discharges the withheld concrete back into the pump line at a rate approximating that average flow rate. The ideal compensator has the withholding chamber size, the elastic stiffness, and the damping rate all at values that passively provide optimal compensation of the abrupt changes in concrete pressure and flow per the cycle of a given piston pump design, based on the line pressure conditions. When this passive response can be optimized, then a minimal amount of powered assistance can then be optimally applied to improve that response where line conditions may require that improvement, or if a constant flow rate output is required.

Compensating devices according to one or more embodiments of the present invention have a primary distinction from existing surge suppression devices, in that existing surge suppression devices serve to smooth the abrupt changes in pumping speed, in order to minimize the jerking action on the pumping line. Existing surge suppression devices are not intended to nor capable of compensating the piston pumping action into a consistent flow rate, rather they are meant to reduce the cyclical surging action on the pressurized concrete pump line. The new compensation mechanisms according to one or more embodiments of the present invention provide pronounced asymmetrical action in the controlled opposing modes of slowly withdrawing and then quickly discharging concrete, with design control disclosed for both modes, and flow priority provided for the discharge mode. With variations of the device, the line pressure and flow changes can be compensated as well as possible, with the passive response optimized. Disclosed herein, according to one or more embodiments of the present invention, are variations of devices, systems, and methods that are entirely passively functioning, actively functioning, and passively functioning with active assistance. Disclosure includes improvements to the design of device geometry, the passive functioning elements, new active control systems, and new means of active assistance to improve the function of a passive device. These devices are designed to compensate the pumping fluctuations that are typical of the piston concrete pumps that are common and available at this time, as additional stand-alone equipment to improve existing pumps, and/or as a system to be built into future pumps.

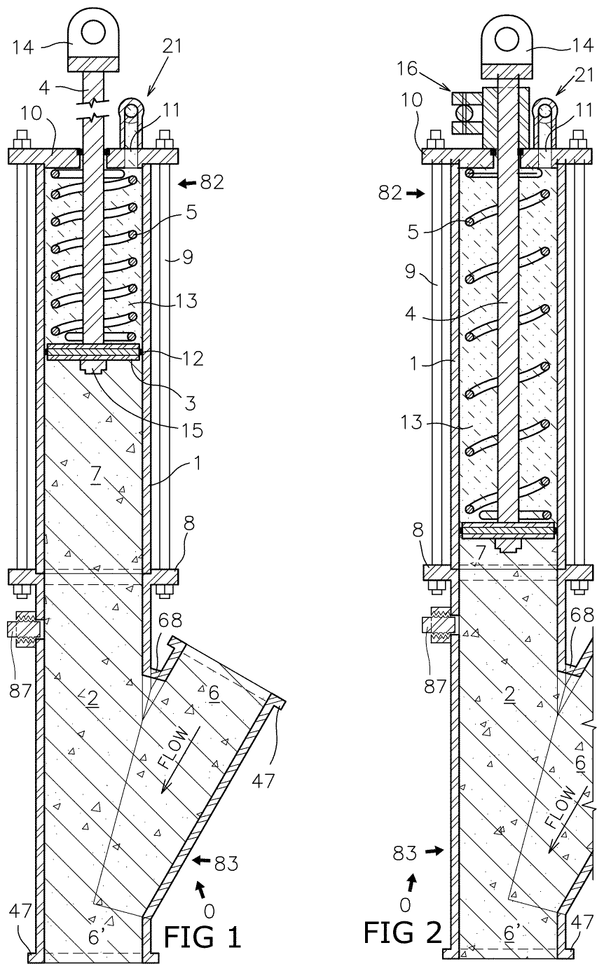

FIGS. 1 and 2 OVERVIEW

FIGS. 1 and 2 show an embodiment of a passive flow compensating device 0 at two different stages of a pumping cycle. This compensating device 0, and various versions, each also referred to as a compensator, is functionally divided into two major parts, a compensating mechanism 82 and a wye junction 83. These two parts are referenced as such, even where the embodiment varies. Variations of compensators that have active or power-driven elements will each also have a version of that major part.

In FIG. 1 an amount of fluid concrete, which flowed in from a pumped line 6, is held within a holding chamber 7 created by a cylinder body 1; and in FIG. 2 most of that concrete is shown expelled back into a flow tube 2, where it discharges through a pumped line discharge 6′. FIG. 1 shows a typical position at normal pumped concrete pressure and flow. A primary spring 5 is selected to have a spring constant to be largely compressed at the normal pressure period of the concrete pump cycle, while having enough elastic force to expand at periods of lowered pressure, typically between piston strokes of the concrete pump.

The spring 5 requires a spring stiffness constant that is appropriate for the pressure ranges in the pumped line 6, and these are determined by the length of the line to the point of discharge, and the frictional factors in that length of line, as well as the specific concrete pump being used, elevation change, etc. A given spring is most appropriate for a given pressure range, and so ideally for a given distance from the point of concrete discharge, considering frictional factors. A preferred location would be right at the concrete pump, for various reasons explained below; and the ideal spring would be matched to the pressure cycle at this location, though the entire device then must be designed for the pressures that can be very high at this location. However for a given spring stiffness, the location may be required to be at a midpoint, between the concrete pump and at a given distance from the point of discharge of the pumped line 6. In order to absorb concrete during the pump cycle, the compensator must provide a lower path of resistance than the line 6, and so the line pressure at that moment must be greater than the resistance created by the spring 5 in order for compensator to fill with concrete. And the spring must also have enough stiffness to expel concrete during the periods of lowered pressure in the pump cycle. For example, one prototype of the passive embodiment shown in FIGS. 1 and 2 was successfully employed in a location 50 feet from the point of concrete discharge, using a spring with an effective stiffness constant of approximately 93 lb/in and having 11 inches of travel.

Other variables affect the optimal spring stiffness. In the case of a compensator with an active component (having a power source for mechanical action or assist of mechanical action), the spring stiffness will vary. If the compensator is equipped with an active component that assists the discharge action back into the pump line, a less-stiff spring can beneficially be used, and/or the compensator can preferably be located closer to the concrete pump. If the active component assists the withdrawal of concrete from the pump line (compensator intake), the spring can preferably be stiffer, such as a spring stiffness up to 300 lb/in and having 7.5 inches of travel; or the compensator can preferably be located nearer to the discharge end of the concrete pump line with a spring stiffness similar to a totally passive compensator. The active intake action of the compensator will allow the device to serve its purpose very near to the end of the pump line, as long as the pressure at that intake is lower than the pressure leading to line discharge.

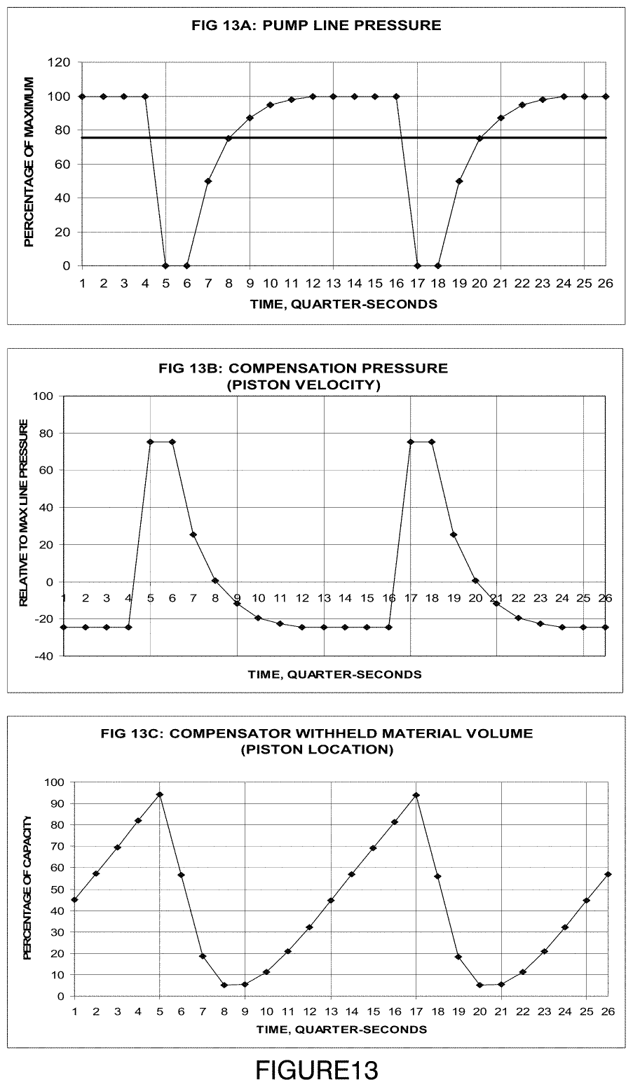

The device requires some damping action to control the concrete absorption rate to match the cycle of the concrete pump. The required damping is affected by the line pressure, and it needs to match the pump cycle period for a given throttle setting of the concrete pump. The damping rate is easily controlled in the field with features disclosed below. This adjustment is related to another adjustment for the spring stiffness, if necessary, also disclosed below. Any damping resistance will lower available rebound energy, and will reduce the available passive discharge response. Device efficiency is increased where elastic resistance slows the withdrawal as is possible, but matching the pumping cycle requires some form of damping. More specific cycle compensation information is shown in FIG. 13.

In this embodiment of the compensator, damping is accomplished by an amount of a flow control fluid 13 that is contained within the portion of cylinder body 1 that is not acting as the holding chamber 7 for concrete. As the compensator spring 5 retracts from line pressure, fluid 13 is let out of a fluid control assembly 21 at a controlled rate. When the line pressure drops between concrete pump piston strokes, the assembly 21 allows free movement in this direction, so that chamber 7 is discharged quickly by the force of then-compressed spring 5, to compensate for the pause in concrete flow.

FIG. 1

According to one embodiment of the invention, the cylinder body 1 can be in the range of 3″ inside diameter and 24″ in length, for many piston concrete pumps. The required volume is primarily a function of the volume of the concrete pump stroke volume. Larger concrete pumps require a larger cylinder body; its size is proportional to the concrete stroke volume—more precisely the volume, at an averaged flow rate, that is missing during the swing tube switchover, and this corresponds to the rate of the switchover. A 4″ diameter cylinder would be appropriate for many larger pumps. In general, a larger cylinder yet would be preferable for a larger pump. Other size factors are discussed further below. A piston rod 4 guides a piston disc 3 that houses a piston seal 12, typically of polyurethane rubber or the like. The rod 4 is not a piston rod in the sense of that in an engine, translating linear to rotational action; it is a rigid extension of the piston. The rod 4 can have a reduced diameter at the disc 3, to create a shoulder where a nut 15 is tightened to affix disc 3 and seal 12, as is common for hydraulic cylinders. The concrete pressure can commonly be over 1000 psi at the pump, depending on the concrete mix, and distance and height to the point of discharge, as well as on the pressure capacity of the concrete pump. Some more recent specialized pumps can achieve even 3000 psi, so of course the operating pressures are essential to design for. These components of the compensator must be of materials selected and sized appropriately for those resulting loads, or the loads of the design pressure based on a given position from the end in the pump line. For example, a compensator designed only for positioning near to the end of a pump line, can be designed for those lower pressures. As hydraulic cylinders etc. are typically meant for higher pressures than concrete pump lines, they are generally suitable for this purpose from that standpoint.

The wye 83 creates a junction where the concrete from the pumped line 6 can flow into tube 2, and can expel as quickly as practical into the pumped line discharge 6′. The need for a rapid discharge is the reason the wye 83 has a discharge path linearly aligned with the concrete line discharge 6′. Further embodiments show a wye 83′ having a turn between flow tube 2 and pumped line 6, where flow line 6 aligns with exit line 6′. In either case, these designs provide significant benefit over the perpendicular, symmetrical, configuration of a tee fitting as used with existing surge suppressors. Having this asymmetrical angle of wye 83′, or the discharge linearly aligned with the following pump line of wye 83, turns out to be a critical factor in achieving an acceptable functioning of a passive compensator that is positioned inline of a concrete pumping line, particularly when combined with the withdrawal/discharge asymmetry in concrete flow control. These asymmetries also improve the functioning of a power-assisted or fully power-controlled inline device, by both reducing power need and improving response. Any geometrical benefit helps where it facilitates the necessarily very-rapid discharge action, while the refilling action of the compensator is slowed by that same asymmetry. The more that the angle is acute, the more that the discharge is facilitated and that the refilling rate is slowed; as the refilling is necessarily much slower that the discharge that must be very rapid, the increasing acuteness (smaller internal angle) is beneficial. At some point the refilling action becomes too slow as the internal angle becomes more acute than around 10 degrees, though this effect depends significantly on the particular internal lubricity of a given concrete mix. FIG. 1 shows this angle to be 30 degrees, which is suitable. The configuration shown is not required, but it is generally best for rapid discharge, and it lowers the importance of achieving the most beneficial acute angle between flow tube 2 and pumped line 6. In this configuration the angle does not affect discharge rate, rather when more acute it affects line flow of concrete making that turn back into tube 2. One prototype of wye 83 performed very well with an internal angle of 20 degrees. It appears that internal angles in the range of 15 to 30 degrees are most suitable for the configurations shown in FIGS. 1 and 2. Other embodiments disclosed further on perform well with larger internal acute angles.

Depending on many factors, this acute angle can preferably range from around 45 to 10 degrees, anything acute of 90 degrees will help the passive response. The material for wye 83 can be of schedule 40 steel pipe, or of the same pipe material that is suitable for pumping pipe lines for the specific concrete pump moving the concrete. This pipe can match that size in use for the pumping operation in question, for example it can be of 3″ (76 mm) schedule 40 pipe material where 3″ concrete hose is in use. In this case, the cylinder body 1 would correspond.

To facilitate concrete flowing from the line 6 about the acute angle and back into tube 2, the apex of the pipe walls at the interior angle are cut out some distance, and with that cut out material sealed off by a filler plate 68, of pipe material welded into place. As this flow rate only need take place at a relatively slower rate—typically where the compensator absorbs concrete over several seconds, some resistance to this flow is not problematic. It reduces the damping action required, in absorbing some of the damping energy, relative to the damping requirement for a tee intersection for example. The effective asymmetrical damping created solely from the geometry of the wye can be exploited. One successful prototype has the distance cut back at 1.25″ from the apex of 3″ pipe intersecting at 20 degrees, for example. Many variations of this geometry will function well, however cutting back too much material here can cause line blockage in that the behavior then becomes that of a reducer with a steep taper.

As the acute angle of direction-change of the fluid concrete containing aggregate presents an issue of wearing through the pipe at the apex at filler plate 68, appropriate measures can be taken for this area. This can include the making of plate 68 of thicker steel material than the pipe material otherwise used; the use of manganese steel, or the equivalent, that is either hard-faced or hard-chrome plated; or the area can be entirely of weld-on hard-facing material. Alternatively, that portion of the wye can be made to be replaceable as a “wear part”. Any of these measures can be suitably applied to any embodiment of the wye presented herein.

Typically a HD flange 47 would be welded on, to make the connection to other concrete pumping hose or pipe end fittings per usual practice, but of course this can vary to suit preferred practices, such as cam lever types of hose connections. The flow tube 2 can be fitted with a mounting flange 8 by welding. Flange can be of ½″ steel plate or the like, and is given holes to fit each of a tie rod 9 to affix cylinder 1, per common practice for pressure cylinders. Flange 8 is fitted with a hole to very closely match cylinder 1 inside diameter and a recess to match cylinder 1 outside diameter. A matched fit with sealant or gasket material, compound combined with sufficient tightening of each rod 9, will make this connection sufficiently pressure tight. An O-ring gasket in a groove per common practice for hydraulic and pneumatic seals is also suitable.

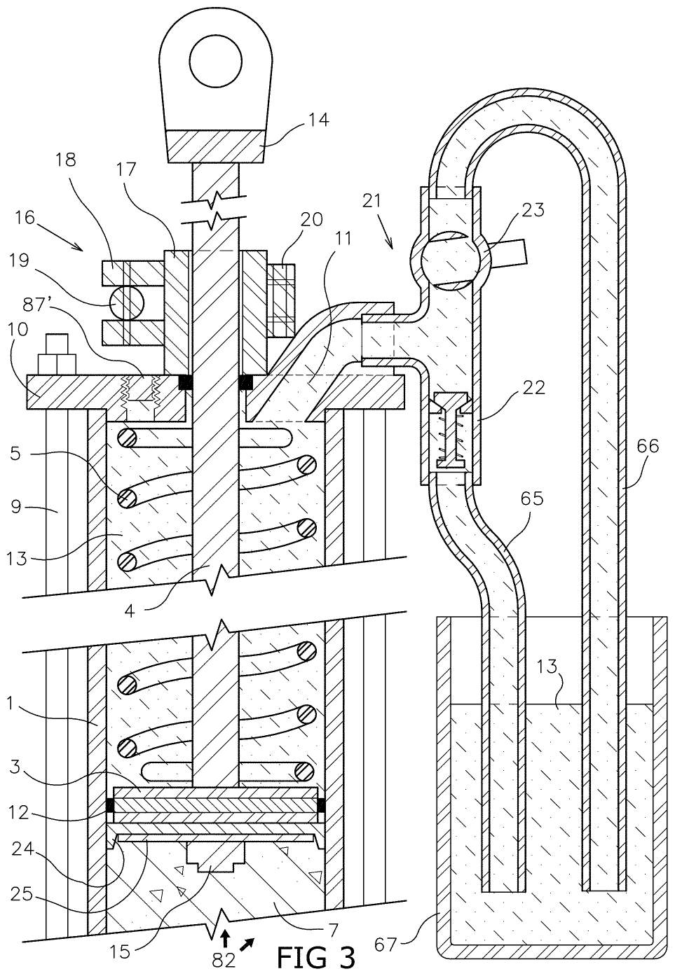

A closure plate 10 can be that normally used with hydraulic or pneumatic cylinders. For the version shown here, it must have a control port 11 allowing attachment of the flow control assembly 21, and can have an additional port, both described in FIG. 3. It is common for a hydraulic actuator in the US to have a port 11 that is ½″ FPT. In some cases, such as with larger concrete pumps and where water is utilized as the control fluid, the port 11 may have to be larger, such as 1″ FPT, to allow more rapid flow back into the compensator at the discharge mode described below.

The flow control fluid 13 is technically a hydraulic fluid and that is what it can be; however it can be any liquid of suitable viscosity and lubricity. The prototype uses plain water satisfactorily, but a non-corroding liquid such as a water-based or water-miscible lubricant, or a lubricant that is compatible with concrete, and preferably that also acts as a cement retarder, so as to prevent the hardening of concrete that tends to remain in the chamber 7 during pumping operations. An example of this is a combination of vegetable oil with glycerides emulsified in water with a polyoxyethylene lauryl ether, or the like, such as is used for metal cutting and lubricating fluids. Of course the entire piston and cylinder system, contact surfaces, and fluids used can be of the same design and manufacture as those used for piston concrete pumps. This is all known art.

Alternatively the fluid 13 can be air or gas such as nitrogen. While compressible, gas creates less resistance to rapid flow; and in combination with the geometry of the wye 83, use of air within the flow control assembly 21 can provide the necessary damping where the line pressure is not too high, such as below 250 psi. The use of air can allow a faster discharge of concrete where the spring 5 is less stiff. This embodiment is suitable nearer to the point of discharge where pressures are lower, and can be an integral component of a robotic concrete placement system. Where air is utilized, some liquid as an oil bath (per FIG. 5) is beneficial for piston lubrication.

FIG. 2

This shows all the elements of FIG. 1, but with the compensator in the discharged position, where the withheld concrete has been discharged from the chamber 7. This discharge action ideally will compensate the abrupt cyclical interruptions of concrete flow.

A collar clamp 16, detailed in FIG. 3, serves to prevent or limit the movement of the piston disc 3. The clamp 16, can be used to initially affix the piston in the discharge position per FIG. 2. Maintaining this position while concrete is first beginning to flow in the pump line helps in minimizing the initial volume of chamber 7, so that less air can become trapped when the compensator first fills up with concrete. Although FIG. 2 shows the compensator oriented vertically, the device is generally operated in a horizontal orientation, and upon initial flow of concrete, it can be oriented so that chamber 7 and tube 2 get filled with concrete. Alternatively, the piston can be affixed per the design shown in FIG. 5.

The presence of air in tube 2 or chamber 7 is more of a concern where the compensator is operating in a higher-pressure location, particularly near the concrete pump, in that the air compressibility at the higher pressure will reduce the volume of concrete exchanged by the compensator, limiting effectiveness. A compensator positioned at the discharge end of a pump line, will have less reduction in effectiveness with some trapped air. In any case, the control of the compensation will be relatively reduced by trapped air; and if very full of trapped air, it will behave more like a less-effective surge suppressor.

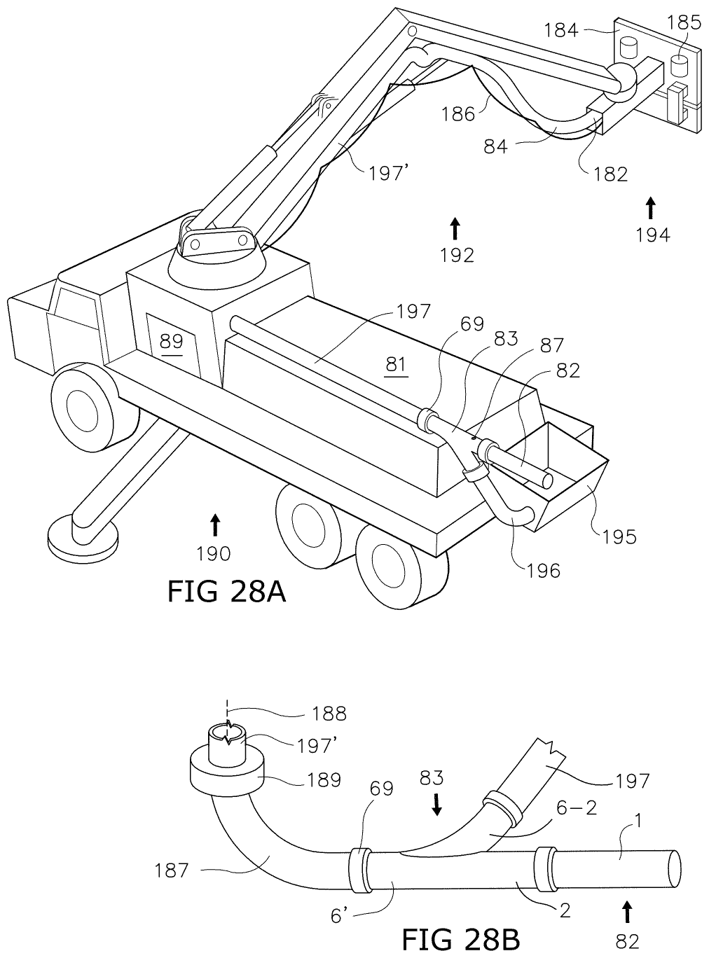

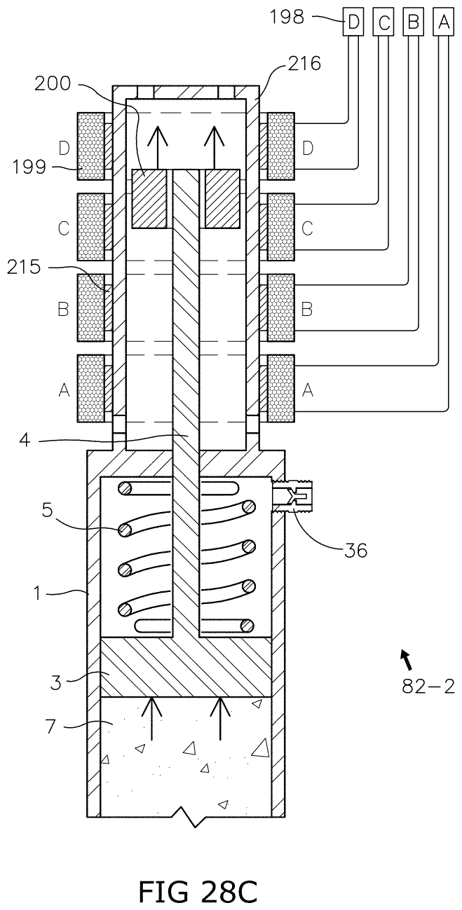

In some embodiments, such as that shown in FIG. 28A, the device is affixed in an orientation where air will become trapped at the beginning of pumping. For these types of embodiments, a means to release trapped air, such as a pipe plug 87, can be employed. This can be a typical male-threaded pipe fitting that can be loosened to release any trapped air as pumping initiates. Also, the access port created by removing plug 87, can be used to add water to tube 2, which can assist the functioning of the device relative to an air pocket. Alternatively, the threaded access port can be used to inject a beneficial lubricating gel, that is essentially incompressible, to fill tube 2 before pumping begins. The gel can be a water thickened with a methylcellulose, or a combination of cement and clay as is used for lubricating pump lines, or any of the thickening agents previously disclosed, for example. Use of a lubricating gel, and even periodic replacement of it during a pumping operation, will extend the life of wear parts, such as the piston sealing elements.

FIG. 3

More detail is shown for the flow control assembly 21. This device allows the fluid 13 to enter cylinder 1 very rapidly, but to exit cylinder at a slower controlled rate. The function is to allow the compensating device to rapidly compensate for pressure drops during concrete pump piston switching, and to refill at a controlled rate where cylinder is recharged in time for the next discharge cycle, per the concrete pump. The rapid intake is allowed by a check valve 22. This valve should be sized to have a flow rate corresponding to the required pump rate of the concrete. For example, to pump 20 cubic yards per hour, the flow rate should be at least about 70 gpm. This may require a check valve that is up to 2″ in diameter, depending on its design, unless air is utilized as the fluid 13. A check valve that is spring loaded such as that shown, is preferable to a swing style check valve. A very rapid action in stopping any reverse flow of fluid 13 is preferable. A control valve 23 can be any that is made for the anticipated pressure, and allows fine control at the low end, to allow fine adjustment of compensator timing. Both valves are connected with a tee fitting that connects to port 11. All of the valves and fittings must be suitable for the anticipated pressure, which is essentially the same as the concrete pressure at that point in the line. A pipe plug 87′ can be removed to provide access into cylinder body 1, as typical for hydraulic cylinders.

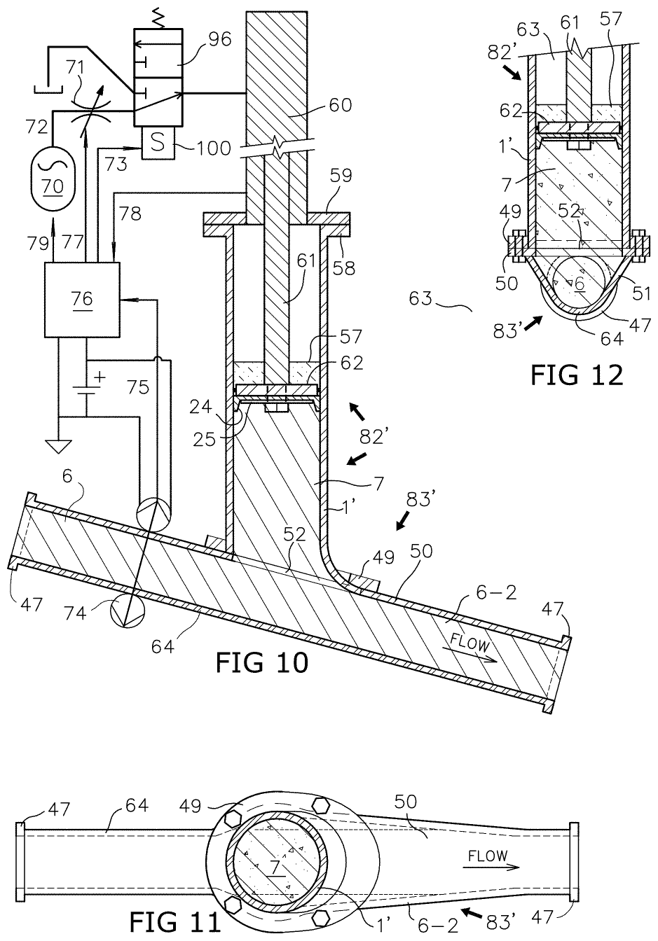

The collar clamp 16 can vary considerably from that shown. This version is two of a half cylinder 17 connected by a clamp hinge 20, and clamped with elements such as two of a clamp fork 18 for each half cylinder 17, those connected by a lock rod 19, that can pin to forks, with the associated clamping nut not shown. Also, the attachment to the closure plate 10, is not shown for clarity. Collar clamp 16 can be anything that stays in place to affix the piston as noted for FIG. 2. It can also be utilized to limit the motion of the piston during pumping, to protect piston elements, but then can remove to assist during line cleaning, such as for a wye geometry shown in FIG. 10.

A preferred seal for pistons pushing concrete material can be with use of a piston cup 24, which can be of a nitrile-butadiene synthetic rubber (buna) or urethane material, and is affixed in place with a cup washer 25. This type of assembly is common to older mechanical concrete piston pumps, to minimize cement and fine grit intrusion getting past the piston seal. The exact piston assembly of such a concrete piston pump can be used here, including the hard-chromed surface typically used for the pump cylinder—that can be used for cylinder 1, and the same lubrication systems can be used if necessary.

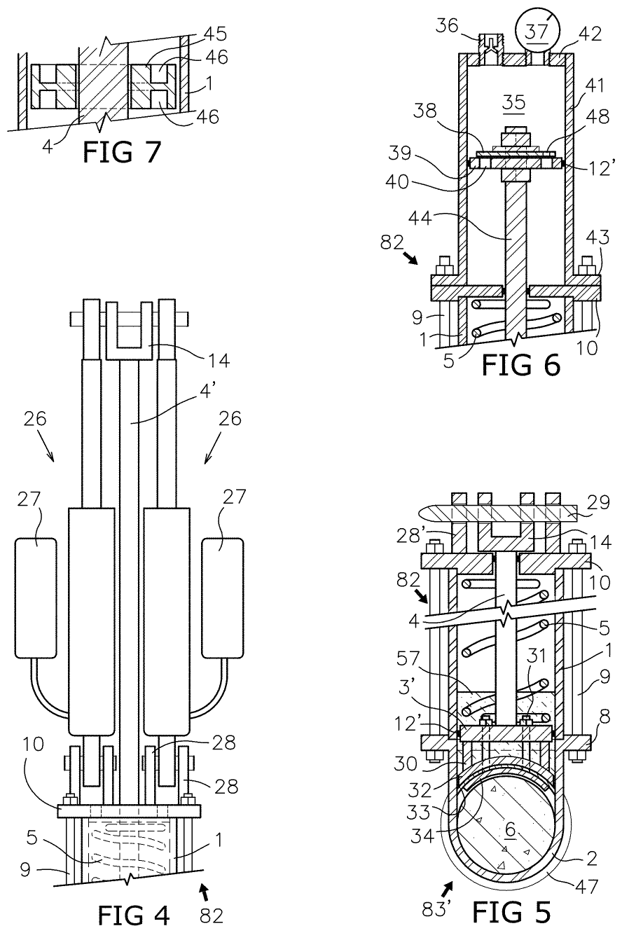

FIG. 4

This is a variation of the compensating control system, where two of a linear damper 26 is used to dampen the rate of extension of rod 4′. Each damper 26 is of the same principle as is utilized for automotive purposes for damping suspension systems as “shock absorbers”. As this is a well-known art, disclosure of the underlying technology is not necessary. This application is most suited to use of “oil” shock absorbers for the loadings and movement control required. Preferably this would be the use of a low viscosity synthetic “shock oil” that maintains its properties during the buildup of heat. Most shock absorbers are designed for impact loads; in this case the load is continuous over several seconds. The industry term for this is a “propelling force” for which these shock absorbers must be designed.

In this case, each damper 26 must provide damping action during extension, but rapid free movement during contraction, to allow the rapid discharge of concrete. The pair of dampers must match damping requirements for a particular concrete pump cycle and pumping conditions closely enough to slow the intake of concrete into compensator, so that sufficient concrete reservoir is available to discharge rapidly for that pump cycle. Preferably they provide adjustability in the damping force, so that varied job operations can be adjusted to. The automotive shock absorbers achieve the one-way damping with use of adjustable check valves that provide free flow in one direction and damping adjustment in the other. Most automotive shock absorbers that could be used in this application would be for heavier vehicles or for off-road use, and may require a fluid reservoir 27, for adequate performance for the force involved combined with the travel distance required—in the range of at least 6 inches (15 cm), with up to several times that distance being preferred for some cases, of course depending on the variables discussed. Such a shock absorber can be up to 4 inches (10 cm) in diameter.

For example, if the compensator is adjacent to a concrete pump reaching 500 psi pumping pressure, and piston 3 of FIGS. 1, 2, and 3 is of 3 inches diameter, then the shock must dampen a force of about 3,500 lbs, in combination with the spring 5 selected, over the period that the concrete pistons are pumping in the pump cycle—commonly in the range of 3 to 4 seconds. Then for the roughly 0.5 seconds or less where the pump is switching cylinders, the compensator is retracting quickly with minimal resistance from the shock absorber, expelling the withheld concrete. Some friction is unavoidable of course, but this action is made to be as fast as practical. More information on this is shown in FIG. 13.

A rod 4′ may need to be longer than the rod 4 to accommodate the length of the dampers. Rod 4′ can be rod 4 with an extension coupled to the top end; such a coupling is not shown, and rod fork 14 then attached to the extension end, where it pins to the end of both dampers 26. Two of a connecting plate 28 are welded to closure plate 8 for each damper connection, or the equivalent. In this case, plate 8 may preferably be fabricated of mild plate steel if these are welded on, but of course the entire closure can be a traditional cast iron product with these connecting plates included.

Alternatively, each damper 26 can be positioned alongside cylinder 1 with appropriate connections at flow tube 2 (of FIGS. 1 and 2), and the pin through fork 14 must be sized for its resulting span to each shock absorber. This arrangement is not pictured.

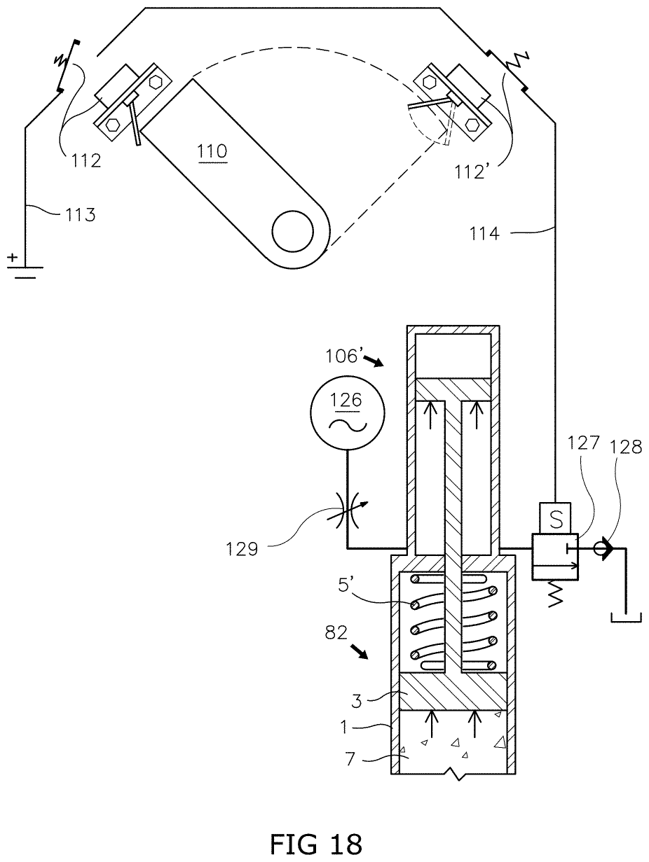

Alternatively, hydraulic shock absorbers can be employed, where the cylinder body is charged with hydraulic fluid under pressure from a hydraulic pump, and check valves are actuated according to the applied pressure by the rod 4′. An active version of this system is disclosed below in FIG. 10, and active hydraulic assistance to a passive system is discussed in FIG. 18.

FIG. 5

This shows a compensator with specific operational details omitted (shown elsewhere), that can provide a consistently-cylindrical pumped line 6 for periods of non-use and for cleaning out the pump line; and also one that can allow a complete discharge of concrete with each cycle, avoiding a possibility of concrete beginning to harden in the compensator during a long concrete placement. The shaped portion that matches the pump line can be made for any angle of intersection between the compensator body and the pump line.

An arc closure 32 supports a seal gasket 33 which is held in place by a clamping plate 34. These elements are shaped to provide continuity of the cylindrical shape of pumped line 6 when compensator piston is in the fully down position. This position can be locked with insertion of a pin 29 through 2 of a connecting plate 28′ and fork 14. Pin 29 can be a construction stake or the like. Any collar clamp 16 (FIG. 2), as may be preferred to prevent damage to gasket 33 during operation of the compensator, would be removed for this positioning. In this locked down position during clean out of pumped line 6, as would be done with a foam ball, or compressed air, or just water; that clean out process will also clean the compensator with regard to concrete build up.

In this case, the piston disc 3′ is modified with a saddle tube 30 that transfers load from disc 3′ to arc closure 32, all by welded attachment or the like. Clamping plate 34 can weld to at least 2 of a connecting stud 33 that fastens though holes in disc 3′. The seal 12′ can be optional in this case. Where all functional seal is undertaken by gasket 33, seal 12′ can be omitted and disc 3′ can have holes to allow oil bath 57 to flow though, or seal 12′ can assist gasket 33, and the oil bath 57 can be sealed in the reservoir between the two. In either case, cylinder 30 requires holes if its interior space is to also contain reserve fluid for oil bath 57.

FIG. 6

This shows another means to provide piston movement control using a sealed air chamber. This system can assist both the spring action and the one-way damping; it is appropriate for lower-pressure locations, such as near the discharge of the pump line. This is where an air piston disc 39 is attached to an air piston rod 44, which is an extension of rod 4.

A flapper valve 38 is attached to disc 39 with a nut and washer at the end of rod 44, where in combination with a set of a hole 40 and the piston seal 12, valve 38 allows air movement into an air chamber 35, but not out of it, as compensator operates. A Schrader valve 36 can be utilized to precharge the air chamber 35 as is the practice with conventional surge chambers, or the air supply can be permanently plumbed to the chamber. The difference in this case is that the surge chamber acts asymmetrically. A pressure gage 37 of course provides pressure information. This air pressure system is shown utilized in combination with spring 5, where the pressure in chamber 35 can be adjusted at the jobsite, so that in combination with the spring 5, the compensator will match the required spring stiffness requirements for a given pumping situation.

The disc 39 also has at least one of a flow control orifice 48, and is sized to control the rate of air flow, and so the movement of piston assembly, in the upward direction, beyond that allowed by compression of air in chamber 35. This allows air pressure to equalize on each side of the air piston disc during the pump cycle, while the compensator is slowly filling with concrete, at a rate controlled by the size of orifice 48. This size would be in the range of 0.015 square inches, but of course would vary greatly according to conditions discussed. The orifice size can be made adjustable to suit given job conditions, but the amount of pressure equalization achieved in this period is not critical, as retraction is unhampered by action of flapper valve 38. Also, the chamber pressure can be monitored and adjusted to help correct the effect of an improperly-sized orifice. Seal 12′ can be a disc or an o-ring held within a split piston disc as is commonly designed for air cylinders. A cylindrical housing 41 is sized for the required action of compensator and for the pressures involved. It is attached to the closure plate 10 with a housing flange 43 that is welded to housing 41, and bolts to cylinder body 1, which can be done with the set of the tie rods 9.

In FIG. 6 no other damping system is shown. Additional damping may or may not be required, depending on the line pressure and other factors. The air chamber 35 in combination with the one-way action of the flapper valve 38, and the geometry of the wye, can provide the required compensating effect under the right conditions, without any hydraulic or other damping assistance.

FIG. 7

This shows a spring aligner 45, which a disc is made of UHMW-PE plastic or the like, to fit loosely inside of cylindrical body 1 and about rod 4, and has two of a spring slot 46 to match each spring. The aligner 45 is helpful when multiple springs are required to be set in series to match a given stroke length, and where the springs are wanted to be kept aligned but not in contact with the other elements of compensation. This can be of the need to keep the springs aligned or to reduce friction by avoiding contact with the other elements.

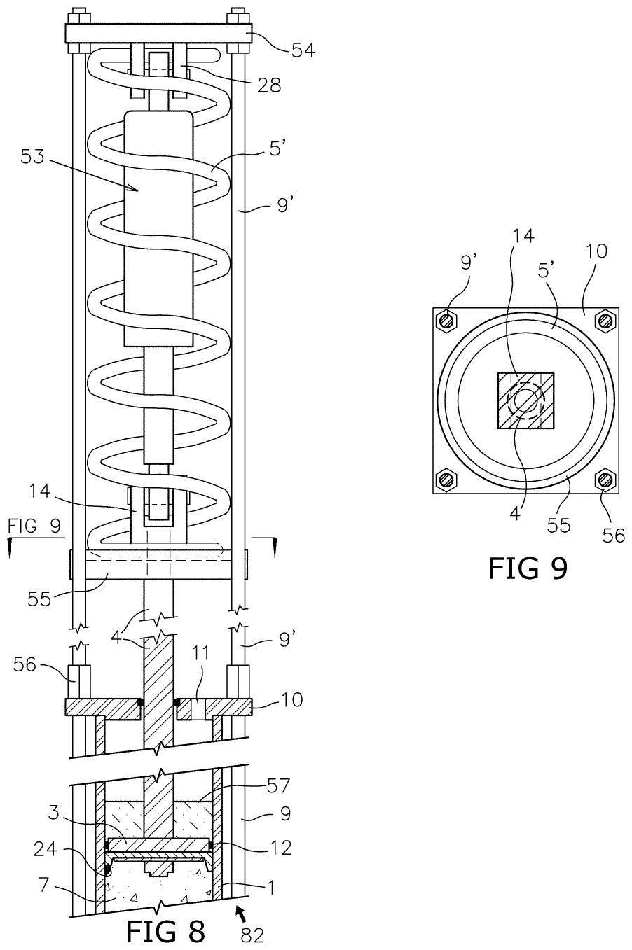

FIG. 8

This figure is an exterior side view of the damping system and a section view of the components previously described. In this case the response is controlled by a single linear damper 53 in parallel with a spring 5′ that surrounds the damper. This can be a “shock and coil over assembly” or “shock absorber with coiled spring” that is manufactured for vehicle use, providing the load response is appropriate for the forces at hand, and the stroke length is adequate. Those systems include elements that are shown discretely here, and so may not be required to be fabricated, if such an existing manufactured assembly is used. In this case, the damping would be provided in the contraction direction, and the extension action would preferably be as free as possible. The spring stiffness K is reduced when the spring length or diameter is made larger, and this spring 5′ must be of a diameter to clear the damper 53; so it may be of heavy rod material, as would be suitable for vehicles, to achieve an appropriate stiffness. Of course the stiffness would be need to be suitable for the anticipated loading, and a spring made of a given wire will become proportionately less stiff as the length increases, or as the diameter increases. In this embodiment where the diameter and length may both be relatively large, the spring may then need to be of a very heavy wire section, as large as 0.375″ diameter, for example, depending on the other variables discussed.

The piston rod 4 is attached to the eye of the damper 53 with a pin. Damper 53 and spring 5′ are able to transmit a response by means of extension of each of the tie rod 9 by use of a coupler nut 56, to connect continuation of tie rod 9′ to a top plate 54. Each of rod 9′ allows adjustment for fit of damper and spring. Two of connecting plate 28 can be welded to top plate 54 to connect damper 53. The spring 5′ can be connected to top plate 54 with U-bolts or equal if preferred; these are not shown.

A lifting disc 55 can be set into rod 4 at a threaded shoulder. It is shown with a recess to accept spring 5′, as also shown in FIG. 9. This support for the spring can be that as manufactured for typical automotive use, so that the lifting disc 55 is not required. Accordingly, elements of a vehicle suspension system can be utilized entirely, where the suspension spring and damper are offset from the load point (wheel location), in combination with a hinge in the system. This allows the amount of travel for a given damper to be increased at the load point as needed, and it increases the rate of travel at the load point for the undamped condition. This geometry is not pictured.

As the stability of the entire mechanism is necessary, the stability of the piston rod 4 must be established by lateral support from the piston seal 12 at the interior surface of the cylinder body 1, and the bearing surface at the orifice of closure plate 10. As the concrete seal can be taken up by the piston cup 24, and this system needs no pneumatic type of seal at closure plate 10, the other elements guiding piston rod can be designed solely for stability. Similarly, the set of rods (9′) can have lateral stability provided by bracing or a safety cover, etc, not shown.

FIGS. 10, 11, and 12 OVERVIEW

FIGS. 10, 11 and 12 show an active, rather than passive, version of the compensating mechanism 82, where the concrete flow rate is measured and corrective compensation is actively provided. This also shows modification to the wye junction 83′, where the pumped line that allows a compensator of a larger diameter than the pumped line to engage and make flow compensations, and a modified pipe 62 that includes both the flow line 6 and discharge 6′. This geometry allows an increased volume of compensation to occur with less travel of the piston system, so allowing a quicker response to pressure drops, and can provide compensation for larger concrete pumps with less stroke length,.

FIG. 10

The compensating mechanism 82′ active system measures and reacts to pump flow rate variations. As it is only filling in the gaps of the pumping cycle, the work required of this system is relatively low; in that the system is not doing a significant amount of pumping concrete, and that the passive, elastically strained elements assist the pumping work. A hydraulic cylinder 60, specifically a hydraulically-actuated linear movement system, is attached to a closure plate 59 by conventional means, such as where the cylinder 60 has a threaded end and plate 59 has a mating female thread. Cylinder 60 controls movement of a hydraulic piston 61 and a piston disc 62 that determine the volume of concrete in chamber 7.

A flow transducer 74 can be located along the pumped line 6 where it will receive a good reading of flow rate; a given length of straight pipe may be required to precede it, per the transducer manufacturer. To allow for delay in the active compensator system response due to frictional and inertial factors, the flow transducer 74 can be located any distance up the pumped line. This hardware can be per a previously cited patent application. A flow rate signal 75 is sent to a signal processor 76, which determines a direction control signal 73 to be sent to a solenoid valve controller 100, and a rate control signal 77 to be sent to a variable control valve 71. Solenoid 100 controls hydraulic directional valve 96. These valve controls, valves, and actuator which are those typical of hydraulic actuator systems, are shown and discussed more thoroughly at FIG. 18. A hydraulic pressure source 70 must be available and be adequate for the action of the cylinder 60. Swing tube type concrete pumps are hydraulically driven and that hydraulic pump system is more than adequate for what this type of cylinder 60 will require. The consumption of hydraulic energy demand from the active compensation is typically less than a few percent of the total energy consumed by the concrete pump.

Alternatively, the flow rate signal 75 can rather be replaced with a concrete pump line pressure signal 75′. Such a line pressure sensor is typical of concrete pumps. What is measured directly is the relevant hydraulic circuit pressure, in this case the circuit pushing the pump pistons. Swing tube pumps also typically also provide the hydraulic pressure for the swing tube circuit. This pressure-based signal 75′ can be sent to the processor 76 as a suitable measure of flow rate. This type of signal system based on pressure would require a timeout routine so that line blockages are not treated as moments of high flow of the pumping cycle. Similarly, a signal from the swing tube hydraulic circuit can be utilized to allow the processor 76 to determine that the solenoid 100 be triggered to reverse direction of the compensator.

For this controlled system, the cylinder 60 will be required to have position sensing, and such a feedback signal 78 of the piston location is required to be sent back to the processor 76, so that processor 76 can make corrections based on piston location as well as flow signal 75 or 75′. When the piston location at a given moment will not allow complete compensation of concrete flow variation, a control signal 79 can be sent to a robotic system delivering concrete, so that the rate of travel at the point of concrete placement can be adjusted, if necessary for a consistent volume of placement. In any case with use under typical jobsite conditions, the robotic placement system will preferably have rate-of-flow information in order to adjust the robotic rate-of-travel, in that the variables the concrete rheology—as it changes with temperature and slump loss; and as pump rate is affected by the pumped distance and elevation change, in order to create a consistently controlled volume of placement.

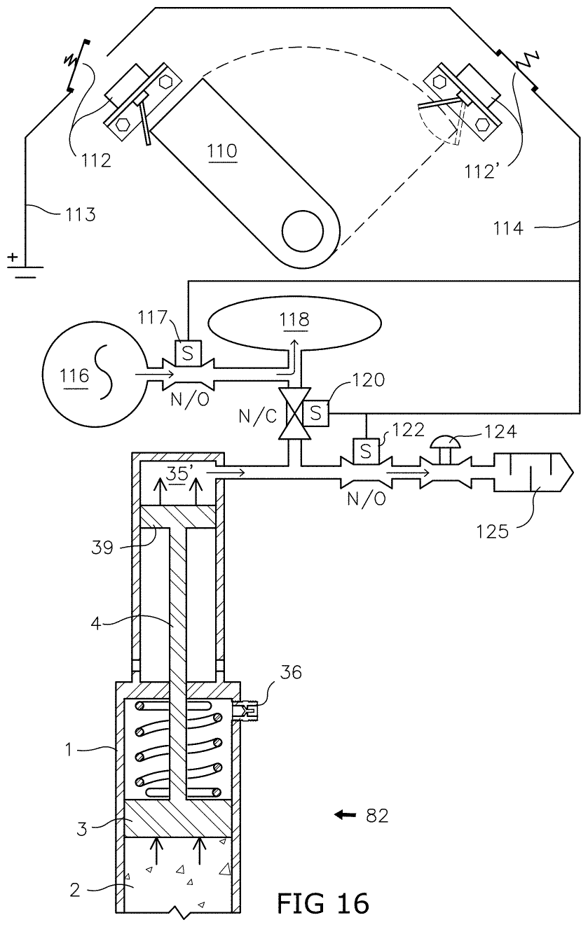

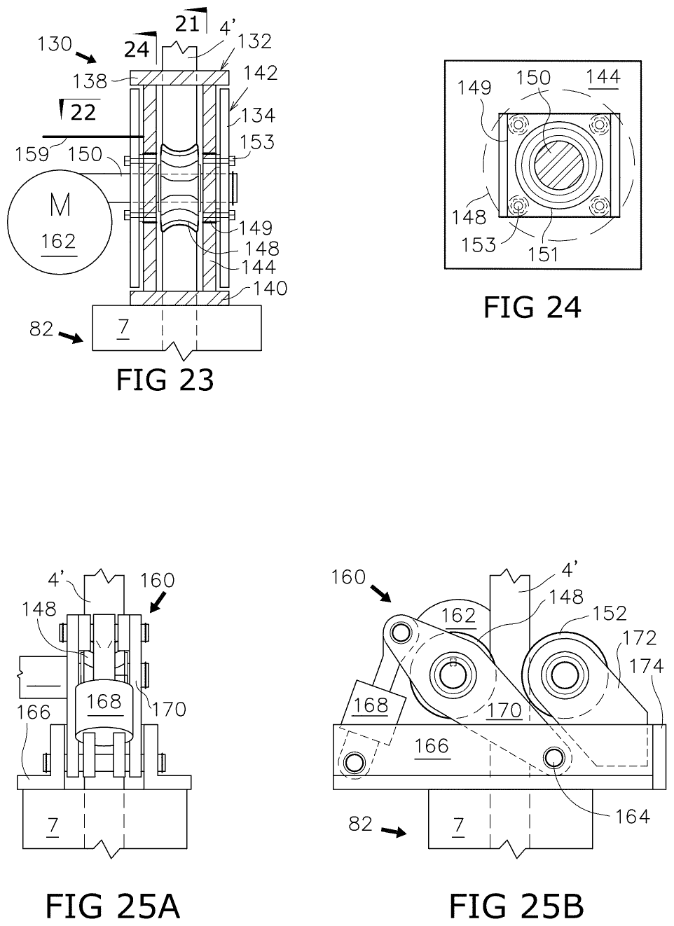

Any of the passive systems disclosed here can be combined with this active system, to minimize the amount of active compensation action required. For example, the air chamber 35 of FIG. 6 can be pressurized according to the flow signal 75 or a pressure signal from the concrete pump, and this can be done cyclically according to the pump cycle, with a means to exhaust the air chamber for each return stroke. This can be to assist the passive system if required. FIGS. 16 through 24 disclose versions of this. Also, the control signal 79, determined by flow rate measurement at any point downstream of a passive or active compensation system, can be sent back to a robotic placement system, to control the rate of movement associated with that concrete placement. This transducer and rate of placement system can all be a system independent and downstream of the compensation system, so that any lack of perfect compensation, or any other variation in concrete flow rate—such as that caused by blockages etc., can be adjusted for in the robotic rate of placement.

FIGS. 11 and 12

This wye junction 83′ has modifications to allow attachment to a larger compensating mechanism 82′ while allowing rapid discharge of concrete into line discharge 6-2. In this example, the flow tube 2 is not present in that the cylinder body itself attaches to the line 6. FIG. 11 is a top view to show the geometry where the cylinder body 1′ is larger in diameter than the pumped line 6 of concrete; the purpose of this geometry is to increase capacity and discharge rate of the compensator. A flat plate 50 is fitted downstream of chamber 7, and the cylinder body 1′ has a fairing at its junction with flat plate 50. The cross section of the line 6-2 is widened by plate 50, seen in FIG. 12. The flow section here is triangular where this part of the pipe 64 is fitted with two of a sloping side plate 51. This assembly has a cross-sectional dimension that maximizes at the chamber 7 and tapers back to a normal cylinder before reaching the HD flange 47 at the discharge end. This design optimizes the pumped line 6 cross-section shape, in order to fit a larger-diameter compensator, while minimizing the required change to the pumped line 6 cross-sectional area, minimizing chances of line blockage. These modifications to the flow tube can be minimized or eliminated while allowing benefits of a larger compensator, if the cylinder body 1′ is modified to be an oval shape, rather than circular, with the long axis in the direction of flow (this embodiment not depicted).

FIG. 13

FIG. 13 shows three graphs that represent an example of concrete pump line pressure/flow variations and a corresponding response of a passive version of the compensator. These graphs are simplified and illustrative, and are of very coarse definition in providing ordinate values at only ¼-second intervals. They show a generalized example of relative values for helping to teach the functioning principles of the compensating device. The period of the concrete pumping cycle is chosen to be 3 seconds (shown in ¼-second intervals); this period is arbitrarily chosen in showing a piston-pump function. Often the piston pump cycle would be longer than 3 seconds.

An essential point to make with these graphics is that the ideal compensator piston position always follows the line pressure variations, and so an entirely passive device, with the passive improvements disclosed herein, can sufficiently compensate flow variations to create uninterrupted concrete flow at discharge, given appropriate pump line conditions. This is because the compensation means is simply that of the compensator piston velocity in response to cyclical pressure changes. The change in piston position always lags behind the velocity. Critical to that is the one-way action of the damping means, which must correspond to the total time difference required between required positive and negative compensation. The wye geometry alone can provide this, for given conditions. Purely for illustrative purposes, this example shows a case where the compensator would fill with concrete over a two second period, and then discharge more quickly it over a one second period. However to accomplish this difference, the compensator must discharge at a maximum rate that is about three times faster than when it fills up, because of momentary lags. Most pumping cycles are of a longer period, and the discharge portion is typically much shorter. For a typical swing-tube concrete pump, its throttle settings may be set to pump for 3 to 4 seconds and switch pistons for less than 0.5 seconds, so requiring the compensator piston to discharge more than 10 times faster than it fills, for near ideal compensation. This type of flow rate ratio would be more common, but would be difficult to graph as clearly. For a passive device, the damper, in consideration of the effects of the wye geometry, must be selected and/or adjusted to provide this time difference from one motion to the other; and the spring must be sized to compress and accept a sufficient amount of concrete under line pressure at that location, yet maintain sufficient rigidity for rapid elastic rebound, for concrete pressures encountered.

Longer pump lines have a tendency to reduce cyclical flow interruptions because of the greater hose length with its inherent elasticity to absorb some fluctuation; also, it allows a passive compensator to have improved performance over one in a short pump line. Much of this improved compensator performance is the result of a higher line pressure that allows the compensator to fill up sufficiently while having a stronger elastic response; and as the line pressure is effectively zero at the swing tube crossover, the resulting passive compensator discharge is stronger. Conversely, if the pumped line is of zero length, a passive compensator will have zero effect, because there is no line pressure to fill it. Accordingly, short pump lines are not conducive to passive compensation. An entirely passive compensator will be able to have an increasing degree of benefit as the length of the pump line increases, and it will provide better pulsation compensation than any surge suppressor for any pump line more than 20 feet in length. For a passive compensator to have sufficient compensation to provide for no interruption of flow at discharge, the pump line length downstream from the device would need to be at least 50 to 100 feet. For an entirely passive device to provide compensation sufficient enough for robotic concrete placement, it would need a downstream line length of at least about 100′, and in many cases this length would need to be longer. Elevation change helps this, in that a concrete boom pump where the pumped concrete has to make an elevation gain up the boom, and then elevation loss back down the boom, will tend to have a significant smoothing effect on the pulsations. In this case a passive compensator such as disclosed herein can provide for no interruption of concrete flow at the discharge, and can provide for a consistent enough flow for robotic concrete placement.

FIG. 13A represents an example of variations in line pressure for a swing-tube piston pump, with the horizontal bar being the average pressure over the cycle, approximately 75% of maximum in this example. For the following analysis, an assumption made is that within a piston concrete pump line that the cyclical flow and pressure variations at a fixed point are essentially coincident; that is, cyclical pressure and flow are generally proportional. This is not the case for line blockages etc, where pressure increases as flow is stopped. With a fluid such as concrete, for the normal cyclical variations of the piston pumping cycle, the line pressure and flow rate correspond closely. Accordingly, the average value shown can be also assumed to represent an average flow rate, which is about 75% of maximum flow rate, for this example. The correlation between line pressure and flow rate allows use of an entirely passive compensator to sufficiently cancel the abrupt cyclical variations in flow rate, by reacting to the corresponding variations in pressure. Accordingly, for normal conditions, FIG. 13A, “PUMP LINE PRESSURE”, could equally as well be titled “PUMP LINE FLOW”.

FIG. 13B shows an ideal compensation response to cancel these flow variations, to create a steady net outflow at the average rate. The ideal compensation to flow variations is the difference between actual and average flow rates. If the graphs of 13A and 13B are summed, a steady state outflow rate results, at the average rate shown in FIG. 13A, about 75% of peak flow. For FIG. 13B, the total amount of concrete filled into the device while line pressure is above average is represented by the total area below the zero axis; and the total amount of concrete discharged from the device while the line pressure is below average is represented by the total area above the zero axis. The sum of these areas represents the required volume capacity of the compensator. The amplitude of pressure/flow compensation corresponds to the velocity of this piston movement in or out. As the piston position function always lags the velocity function, this allows an entirely passive device, where the piston position is driven by the line pressure variations, to provide the flow compensation described, which is a function of piston velocity. The piston only needs to be moving in the right direction to provide immediate compensation; and providing that the optimal spring and damping forces are provided for the pump cycle and pressure conditions present, the compensator can neutralize the cyclical pressure and flow fluctuations to create an essentially steady flow rate.

In reacting to the very sudden pressure changes, the passive device will have an unavoidable lag in response velocity, due to combined frictional forces and the total mass attached to the piston. This velocity lag effect is most noticeable is at the moment a swing tube concrete pump begins the cylinder switching process, when the pumping cycle has the very abrupt pressure drop, as seen at abscissa 5 and 17 in all the graphs of FIG. 13. This pressure drop within the pump line begins sometime after moments 4 and 16, and occurs over less than a ¼-second interval. Assuming normal preferred operation, this moment is when the piston has loaded the spring to a practical maximum compression, and any damper is starting the free motion (discharge) direction. This is when the device will respond most rapidly to any pressure drop, compared to any other point in the pump cycle; but it cannot instantaneously change direction, there is a small amount of lag.

FIG. 13C shows the piston location, based on passive response to the line pressure variations, where its position shows up to a ¼-second lag in response time. In this case, the ¼-second time increments of measurement are the reason for this lag in value. If finer data increments were shown (the theoretical function of graph 13C is the integral of the function of the graph 13B, inverted), this lag would express as a curve at moments 5 and 17, rather than the instantaneous change shown by the coarse ¼-second sampling. This curve would be starting between intervals 4 and 5, and 16 and 17. The amount of velocity lag will shift the pressure compensation function of FIG. 13B by the same amount. This has the most effect at moments 5 and 17, where the up to ¼-second lag occurs at the maximum pressure drop, causing a change in net outflow over that ¼ second period. What happens afterward is that, because the piston is highly spring-loaded at the moment of pressure drop, the compensation also lags the line pressure recovery; so that the brief drop in outflow is followed, within about a quarter of a second, by a brief surge in outflow. Given the amount of elasticity of the typical concrete pump hose line, these variations can be smoothed by the remainder of the pump line to sufficient degree, allowing the passive compensator in that pump line to effectively deliver a constant enough flow rate to allow the robotic placement of concrete. In field testing, this velocity lag effect been noticeable but insignificant when there is at least 100 feet of pump line beyond the compensator. When the concrete contains entrained air, this provides fluid compressibility to better smooth out the compensator velocity lag, with a shorter length of pump line following the compensator

Given the conditions noted above, this compensation creates a net output flow rate that is consistent enough to allow an acceptably consistent volume of material placement while the discharge aperture is being moved at a constant rate. This benefit allows robotic placement, without a need for variations in the placement rate that must correspond to each cyclical flow rate variation of a piston concrete pump. This kind of jerky motion would be too difficult to control and the control equipment would wear out quickly, making robotic placement of concrete impractical or impossible without the compensator, where a swing-tube type of piston pump is used.

The average flow rate shown in FIG. 13A would be the same as the pump production measured in cubic yards per hour. For example, if a particular robotically placed additive manufacturing process was to be run at 10 cubic yards per hour, this equates to an average flow rate of about 130 cubic inches per second. If the compensator needs to discharge concrete to match this average rate during a half-second (or less), for example, while the swing-tube is switching, then it needs to have a capacity of around 65 cubic inches—ideally to all be discharged during that half-second or so, at a rate of about 130 cubic inches per second. The compensation will not be perfect, but in combination with further smoothing effects from the pump line; the resulting flow will be constant enough to allow the additive manufacturing to take place at 10 cubic yards per hour.

It should be noted that because of irreversible frictional effects that reduce the maximum possible compensation reactions, the passive device performance cannot by itself provide a perfect compensation effect. Energy put into damping does not rebound. Where the pump line conditions (such as a short line length) and the concrete mix (such as a very stiff mix with low air content) are counterproductive to providing a consistent flow at discharge, then at least some powered assist would be required for the compensator to ensure a discharge consistent enough for robotic concrete placement means. The improved passive design features disclosed herein are extremely beneficial, even where some power assist is utilized in conjunction, in that the power input and equipment wear are minimized with the improved passive design embodiments included, and the flow consistency is improved as well.

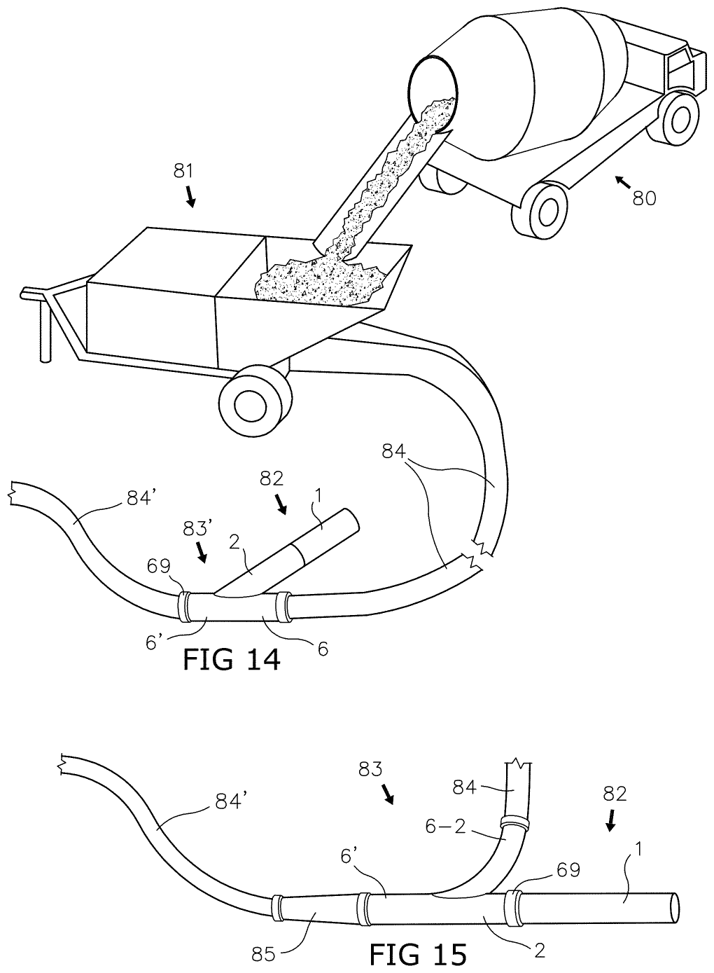

FIG. 14

This shows a concrete delivery system where redi-mix concrete is delivered by a concrete truck 80, and then pumped with a swing-tube concrete pump 81 into a length of concrete pump hose 84, that is attached to wye 83′ and compensator 82, that may be of any embodiment disclosed herein. Another length of concrete pump hose 84′ continues to an application for placement of the pumped concrete. Pump line connections, such as an HD flange clamps 69, and details of the pumping line, such as the line reduction and elbow right behind the pump, are not shown or are non-specific as this is all known art. The embodiment of the wye 83′ shown is one where pumped line 6 aligns with pumped line discharge 6′, and flow tube 2 intersects at an angle. The concrete discharged from tube 2 makes a turning angle to flow along line discharge 6′. A preference is to provide as small a turning angle as practical, in order to reduce friction in the concrete discharging from tube 2.

FIG. 15

This shows a compensator 82 of with a wye junction 83 having a pump line sweep 6-2 as a long curved elbow merging into the flow tube 2, and discharge line 6′, much like the arrangement of a sweep wye cast-iron wastewater fitting, where the centerline of the sweep 6-2 arcs to tangent of the centerline of line 6′. For this design, the turning angle of sweep 6-2 is not important—as long as it facilitates passage of concrete, because the path into the concrete discharge line is straight, which is optimal. In this case, flow tube 2 can be of the same diameter or of a larger diameter than line 6-2 so that greater compensation action can be gained from less linear movement of compensating mechanism 82, and so that a more rapid discharge of concrete is possible. This is the most effective wye geometry—with regard to achieving a very rapid compensation at the pumping piston switchover. For example, where the hose 84 and sweep 6-2 are of 2.5″ pipe, the cylinder body 1, flow tube 2, and line 6′ can all be 3″. Alternatively, the sweep 6-2 can be of an elbow reducer, from 3″ to 2.5″, then flow tube 2 can be 3″. In these cases, a reducer 85 would be required downstream if the hose 84′ diameter is to match hose 84 diameter, but this is not necessary. Any reducer does not need to be attached directly to wye 83′ as shown; in fact, some distance away can be preferable to reduce the chance of blockages. The length of pump hose 84′ following is preferably one that creates a line pressure suitable to facilitate function of a given compensator, and also that smooths any remaining flow variations that make it through compensator. More specifics on this are discussed with FIGS. 1 and 13. These figures show concrete pump hose being used as an example, but of course the concrete flow conduit can be of anything that works, such as rigid pipe etc.

The sweep version of pumped line 6 can be the same sweep elbow fitting that is typically found right at the discharge of concrete pumps, and is commonly of a larger diameter than the hose 84, for example 5″, and in this case the sweep 6-2 can be made of an elbow fitting that tapers to 4″, and is intercepted by a flow tube 2 that is 5″. There can then be a reducer that goes back to 4″ immediately beyond the wye. In this case, the compensator can be essentially right at the pump. Alternatively, the wye 83 can be near to the point of concrete discharge, and/or can connect directly upstream of an inline mixer, for the purposes of modifying concrete for additive manufacturing applications, etc. In any case, the use of a heavy sweep elbow built for concrete pumping will have good wear durability in this application.

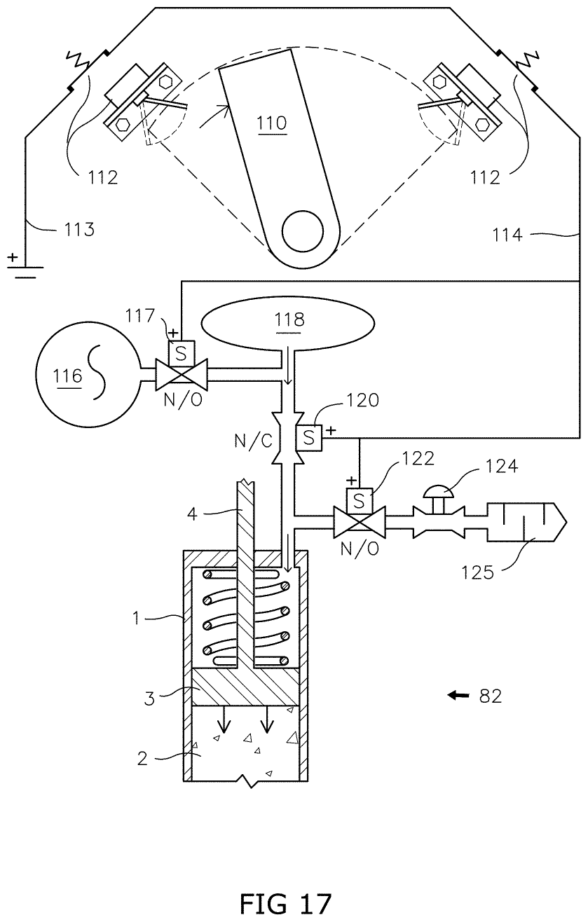

FIGS. 16 and 17

These drawings show an embodiment of a pneumatically assisted compensating device in that the rapid discharge action is augmented with a power source—in this case pneumatic pressure. Hydraulic assist can substitute for the pneumatic, with examples of that circuitry disclosed with FIGS. 18, 19 and 20 below, though in combination with using the control “signal” shown here. FIG. 16 is shown during the normal pump cycle of a piston pump, where the compensator 82 is withdrawing concrete from the pump line; and FIG. 17 is shown during the crossover action of the swing tube, where the compensator 82 is discharging concrete into the pump line. The difference in “control signal” is seen in a “representation of the swing tube” 110, shown locked at the left side position in FIG. 16, and at a mid-position-moving to the right position, in FIG. 17. Representation 110 is to indicate the physical position of the swing tube, though it can be another physical object, such as a rocker arm for the attachment of crossover actuators, etc. It can represent the position of an equivalent concrete switchover valve, such as the Schwing Rock valve, etc. In this embodiment, this physical-object representation of the position of the swing tube position is utilized to activate different modes of the compensator, in that control switches are positions to activate based on the position of that physical object. This can be as simple as mounting control switches, by fasteners or by mounting a panel having hook-and-loop positioning of the switches, where a rocker arm, or appendages attached to the rocker arm, etc, make contact with the switches. In FIG. 16 the compensator is absorbing concrete relatively slowly, and in

FIG. 17 it is discharging concrete quickly. Both drawing figures show the compensation mechanism 82 at the bottom, but only FIG. 16 shows an air chamber 35′; this is just so that these two variations of the device can be shown. To achieve more assistance force from a given available maximum pneumatic air pressure, the diameter of chamber 35′ can be greater—even greater than the cylinder 1. Where a very high pressure source is available, such as high pressure carbon dioxide or nitrogen, the diameter of chamber 35′ can be much smaller than cylinder 1. The preferred pneumatic pressure relative to the concrete pressure required can be used to determine the preferred relative area of piston 39 to piston 3.

FIG. 16

A spring-loaded toggle switch 112, that is normally in an “on” or “open” position is positioned and securely fastened in order to toggle into a “momentary off” position when contacted by representation 110, and is shown switched into the off position. An identical toggle switch 112′, also spring loaded in the normally on position, It is positioned to toggle off when the swing tube reaches the right side position. A 12-volt DC circuit 113, or equivalent, is shown, with the toggle switch 112 shown symbolically in the open position, and 112′ in the closed position. With these switches in series, a control circuit 114 requires both to be closed to power up a set of solenoid valves. With the swing tube at one side or the other, the solenoid switches will not activate and so will remain in their “normal” on position.

A source of compressed air 116, which can be of normal operating pressure of around 150 psi, passes through a normally open solenoid valve 117 to fill an air accumulator 118, which is simply a small tank to create a controlled volume of compressed air. In parallel, the air chamber 35′ is exhausting air though a normally open solenoid valve 122, at a rate allowed by a control valve 124 to provide damping effect, and exiting through an optional muffler 125. This action of the compensator is passive, where the concrete line pressure is pushing the piston 3 so that the device is filling with concrete at a rate depending on that concrete line pressure, the spring 5 stiffness, any pre-charge pressure provided by the

Schrader valve 36, and the setting of control valve 124. In this case the spring stiffness can be lower than that of an entirely passive compensator, and if this version of the compensator is located near to the discharge of the concrete pump line, the spring stiffness can be down to the range of 50 lb/in. The pre-charge pressure using the Schrader valve 36 can be used as an onsite adjustment of the effective spring force. The rate of filling the compensator is preferably matched to the period of the pump cycle; valve 124 can be manually adjusted for this purpose. During this period the accumulator tank 118 is also charging up to the pressure of air supply 116.

FIG. 17

Once the swing tube (position representation) 110 has moved off the side position, both switches 112′ have sprung into the on (closed) position, so activating all the solenoid switches. Now valves 117 and 122 are closed and valve 120 is open. This allows the air pressure accumulated at 118 to rapidly fill into the compensator 82 at the moment needed, to help boost the force created by the compressed spring 5, so boosting the device compensation response. This boost makes it possible to have uninterrupted flow at concrete discharge.

For example, if the compensator cylinder, or attached air chamber, air volume is 0.10 cubic feet or 0.75 gallons, and the accumulator 118 is 1 gallon, the average pressure on the piston would be at half the cylinder volume plus the accumulator, the net average pressure is about (1/1.375)=73% of the line air pressure. At 150 psi, this adds about 110 psi (max) to the compensator (same diameter cylinder), above what it already had from the coiled spring, etc. If more pressure is required, the air pressure system can be increased.

To determine the air volume requirements, if one assumes a concrete piston stroke every 4 seconds, and 0.10 cubic feet at 150 psi is about 11/6 more cubic feet at 90 psi (for SCFM), so that at least 0.183 cubic feet at 60 sec/4 sec=2.75, so at least a 3 SCFM compressor would be necessary. This capacity is available in a small portable compressor.

As small compressors with air pressures over 150 psi are less common, it is good for the air assist version of the compensator to still maximize the passive reaction.

The accumulator tank is not necessary in that the air supply can simply connect directly to the normally closed valve 120. This simpler alternative will work, if the compressor tank can be near enough to the compensator to allow a very rapid transfer of air into the compensator. In either case, the valve 120 and lines to it need to allow rapid transfer of air pressure. The valve should be a size of at least of ¾″, and the lines if only ¼″ hose should be less than a total of several feet in length, so that a very rapid pneumatic pressure transfer is possible. Also, there are many variations of the electric circuit and air valves that provide the same function as shown here. One simple version was chosen for this disclosure. Other versions, such as utilizing two accumulator tanks with separate control circuits, one assigned to each end position of the swing tube, have also proven to work.

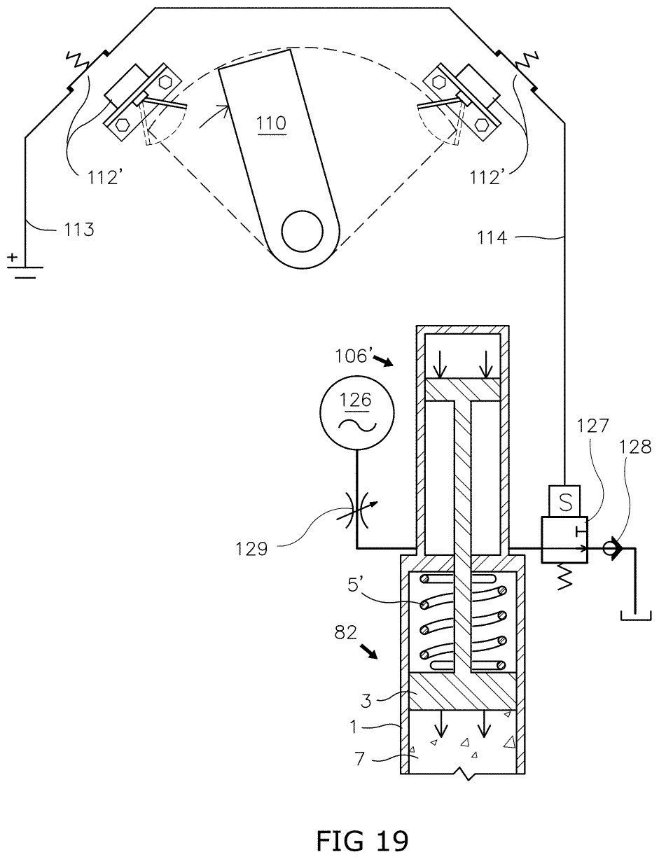

Embodiments of the present invention such as those shown in FIG. 16 and FIG. 19 include spring 5 as described above. In view of the present disclosure, it would be clear to persons of ordinary skill in the art that alternative embodiments of the present invention may not include spring 5. In other words, spring 5 is optional for one or more embodiments of the present invention.

FIG. 18

This shows a version of motion control for the compensator that utilizes active control and/or assist for the withdrawal of concrete. The power for this assist is shown to be that of hydraulic fluid, though it can be delivered via water such as is shown in FIG. 3 or air such as is shown in FIGS. 16 and 17. The hydraulic power source would conveniently be that of the concrete pump system; a portable water-based hydraulic system would be a convenient variation of a stand-alone portable system that is not necessarily an appendage to the concrete pump. This power assist allows the use of a stronger spring 5′ than of the entirely passive device; in this case the spring stiffness can be over 100 lb/in, for example, and/or the device can be located very near to the end of a concrete pumping line.

The same control circuit of FIGS. 16 and 17 is utilized to send a signal to a normally closed solenoid valve 127, so as the swing tube representation 110 holds one switch 112 open, valve 127 remains closed, allowing hydraulic pressure source 126 to fill a single-acting actuator 106′, retracting the compensator 82 at a rate controlled by a flow control valve 129. A hydraulic line 86 to other system devices is anticipated to be present, or pressure overrides need to be present, so that pressure source 126 can constantly run without having to work against a dead head. The adjustment of valve 129 preferably creates a flow rate with the filling of actuator 106′ matching the concrete pump cycle so that the compensator is both filled continuously and sufficiently full before the swing tube switches over.

FIG. 19

This shows the system with active assist for filling the compensator where multiple valves are utilized to allow a more rapid evacuation of the hydraulic fluid, or an equivalent fluid that may be used. As the swing tube representation 110 is switching cylinders, the control circuit 114 powers and so opens both valve 127 and additional valve 127′. A check valve is not shown on the line to the pressure source 126, but can be present if required for reverse flow protection. As the spring 5′ can be stiffer as noted, then the discharge can be more abrupt to better compensate the cylinder switching, and multiple hydraulic evacuation lines also make this possible.

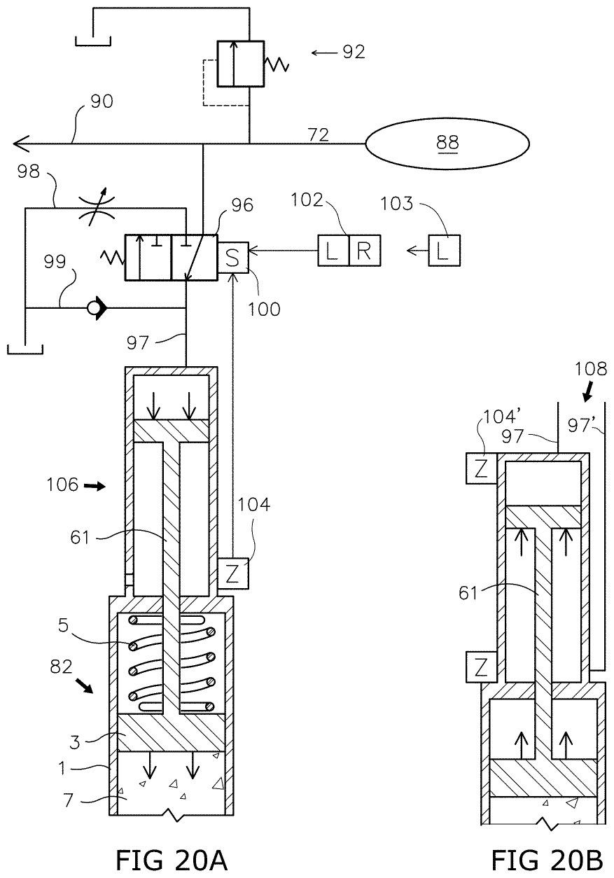

FIG. 20A

This drawing shows a version of the compensator that utilizes a hydraulically powered assist, using a single-acting hydraulic actuator 106 to assist in a more rapid discharge, shown in the discharge mode. In this example, the hydraulic accumulator tank 88, as is commonly in place in concrete pumps to power a more rapid switchover of the swing tube, however most any suitable hydraulic power source found on a concrete pump would be suitable. A hydraulic line 72 that leads to a crossover 90 actuator for the swing tube, is tapped to connect to a solenoid valve 96. A check valve system 92 can be installed to prevent damage if the added circuit is not up to the accumulator maximum delivered pressure. On the concrete pump cylinders there are sensors L and R 102 that indicate when the left and right pistons have pushed out fully, triggering a crossover actuation of the swing tube on the accumulator circuit. Alternatively, these can be multiport hydraulic sensors rather than electronic. In either case, this signal triggers a solenoid 100, setting valve 96 to the position shown, where hydraulic pressure actuates a single-acting cylinder 60′, pushing rod 61 and piston disc 62, assisting in a more rapid discharge of concrete from compensator. This hydraulic assist is stopped when sensor Z 104 sends a position signal to the solenoid 100, switching valve 96 to empty cylinder 60′ under pressure from the concrete pump line. In addition, the hydraulic assist can be stopped when the signal from sensors 102 stops—meaning that the concrete pump piston has started to move again, as indicated by the spring symbol on valve 96. Alternatively the signal sent to activate valve 96 can be made by the same signal C 103 sent to activate the crossover valve—in each direction; and alternatively the line 97 can be pressurized by tapping into the same hydraulic circuit that activated the crossover actuator—in both directions, in lieu of the circuit shown here. This last option, while very simple in just tapping into one existing circuit, will need the use of sensor 104 to terminate the action, as the crossover circuit holds it each side during that entire pump piston cycle.

The rate of fill of concrete into compensator is controlled by a hydraulic flow control line 98. A check valve line 99 allows concrete to discharge if accumulator 99 is expended of pressure too soon

Alternatively, the entire hydraulic assist process starts and stops simply as another leg of the crossover circuit 90, using both the left and right branch of the circuit, as the timing and duration of the crossover actuation is essentially identical to an ideal boost to the compensator. In any case, as the hydraulic pressure is much greater than the additional pressure required to move assist discharge of the concrete, the sectional area of cylinder 60′ can be proportionally less than that of flow tube 2.

FIG. 20B

This is another example of compensating system utilizing a dual acting hydraulic actuator 108, with hydraulic line 97 for discharge and 97′ for retraction—which has a flow control valve; and with sensor 104 to stop discharge assist, and sensor 104′ to stop intake assist. A primary advantage of this system is the preferential path provided for the concrete according to other disclosures herein.

For any of the active systems shown, where any type of signal from the concrete pump system is utilized to initiate compensation action, any delay of the mechanics of any of the compensation systems shown can be adjusted for by an integrated control system. For example, the inertial mass of the moving parts and the concrete to be expelled will cause a delay in the device response to a controlling signal. In this, the concrete pumping control system that controls when each cylinder switchover will occur, can also control when the compensation will occur. The timing for the signal sent to the compensator active system can precede the signal sent to the concrete pump switchover by the interval required to achieve simultaneous compensation.

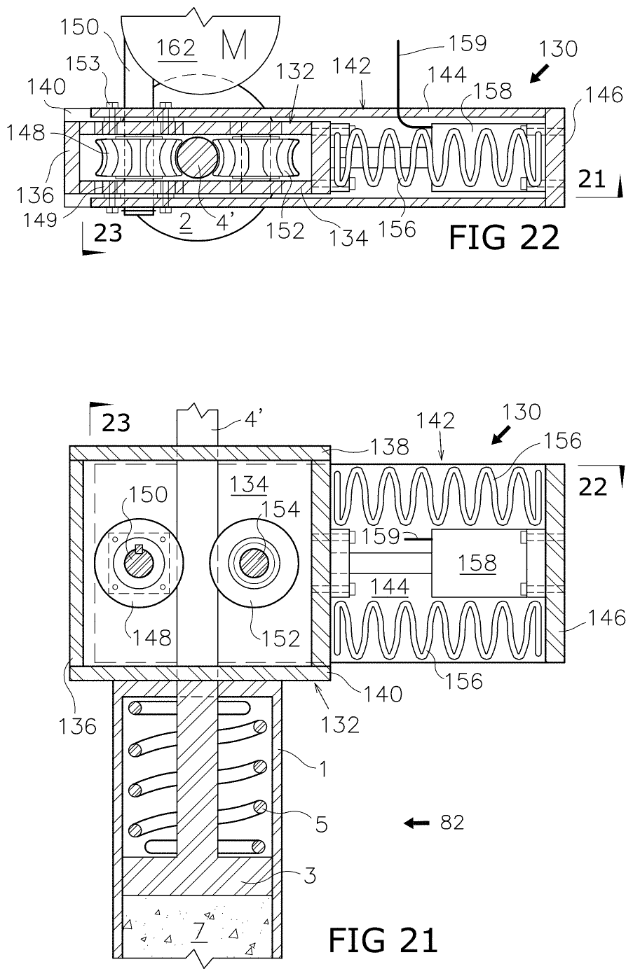

FIGS. 21, 22, 23, and 24

These drawings all show different section views of a version of a type of compensator that utilizes mechanical retraction to withdraw concrete from the pumped line, while using elastic spring 5 force to expel the held concrete. Mechanical retraction allows a constant rate of concrete flow into the tube 2, and so serves the same purpose as that served by the damping devices previously disclosed. In the case of mechanical retraction, the withdrawal action is independent of line pressure, so that the pump line, both upstream and downstream of the compensator 82, can be of any length. This version of the compensator can function if located at the pumped line discharge, as the withdrawal pressure in the tube 2 can be below atmospheric. Alternatively, it can be located just downflow of the concrete pump, as the mechanical retraction provides concrete withdrawal against a very high spring force—so that the concrete can then be expelled very abruptly.

An advantage of the one-way mechanical version of compensator is that the behavior can be made to very closely match the ideal compensation cycle shown on plots of FIGS. 13B and 13C, in that a steady influx on concrete worked steadily against a strong spring force, can then be combined with a very abrupt pressure rise into the pumped line. This compensation allows a uniform flow at discharge, such that robotic placement of concrete can be made without a need for adjustments to the rate of travel. The compensated flow rate is constant enough that concrete placed at a steady rate of travel at discharge, can have a continuous placement volume that is consistent enough for additive manufacturing construction methods, using a piston concrete pump.

A piston drive 130 is utilized to withdraw concrete into tube 2 by means of a drive pulley 148 and a compression pulley 152, along with the effect of concrete line pressure. These pulleys serve to translate the piston rod 4′, which in this case does not need to have a smooth surface in that a pressure seal at the top of tube 2 is not required for this version. A texture on rod 4′ can be present necessary to engage the drive pulley. Materials and elements of the “rebar climber” disclosed in provisional patent application 62/793,868 ADDITIVE LAYERING SYSTEMS FOR CAST-CONCRETE WALLS by this same inventor, are suitable for corresponding elements for this present invention.

The piston drive 130 is made up of a support box 132, that fits inside a larger compression box 142 with appropriate clearance, so that mutual translational movement can occur between the two boxes. The drive box is attached to the compensator 82 and provides support for each bearing for a drive shaft 159, having a keyway for the drive pulley 148 and for a power source, such as a motor drive 162; and support for each bearing for a compression shaft 154 for a compression pulley 152. The motor drive 162 can be electrically or hydraulically powered. Significant speed reduction is required for electric power, for example, as the preferred speed for pulley 148 is in the range of 1 rpm. The power required is low, given the mechanical advantage and in that the concrete line pressure assists; so the motor and drive system initially serves as a piston rate limiter similar to the dampers of previous embodiments shown, and as the spring 5 loads up in compression, the power of the drive 162 helps to increase that compression further than a passive system. This allows use of a stronger spring 5 and a greater range of motion with a given spring 5, so that the response at discharge can be greater.

Relative motion between box 132 and box 142 is used to control and release pressure on rod 4′, so that the drive pulley 148 can be engaged and disengaged to rod 4′. Per FIG. 24 one can more clearly see the drive pulley bearings 151 are each pressed into a drive block 149. A cut out is made in each of a side plate 144 of support box 132, to allow the block 149 to slide horizontally, as it is fastened to a side plate of compression box 142 with a number of a machine screw 133.

During normal concrete pump flow, two of a compression spring 156 engage against box 132 by an end plate 145, to maintain pressure of drive pulley 148 on rod 4′. When a hydraulic line 159 activates a hydraulic actuator 158 in retraction, the drive pulley 148 is disengaged, and the force of spring 5 discharges concrete. Hydraulic line 159 is activated by a control system such as that shown in FIG. 20A, where hydraulic flow results from sensors of the concrete pump system. Alternatively, line 159 can be a pneumatic line, activated by a system such as is shown in FIG. 17, where actuator 158 is pneumatic, or the control system can be a combination of these. The loading required to release the load of springs 156 can be, for example, in the range of 450 lb. This would be where the drive pulley 148 coefficient of friction on the rod 4′ is effectively around 0.7, and a minimum required retraction force on the piston disc 3 is 300 lbs. A pneumatic piston would then need at least 3 square inches net exposure at a 150 psi air supply to realize a 450 lb release force. This would be a reasonable minimum, and larger is required for developing a higher retraction force. The size of a pneumatic cylinder used for this purpose could determine the required size the piston drive 130, or at least the compression box 142 required inside dimension.

FIGS. 25A and 25B

These drawings show a pinch drive 160 that acts on the same principle as the piston drive 130, except that the engagement with the rod 4′ is made by a pivot motion rather than a translation. Two of a pinching bar 170 pivot about a lower pin 164 that also runs through each of a linear mount 166. The pinching bar rotation is accomplished with an actuator 158. This geometry provides mechanical advantage for the actuator, in terms of lever action and angular load component—either of which can be adjusted by the geometry—such as the lengthening of the pinching bar 170, so that the actuator 158 linear force is multiplied as a pinching force on the rod 4′. This geometry makes a pneumatic actuator more practical for higher withdrawal loads of rod 4′, and allows a smaller diameter pneumatic cylinder or a lower air pressure to be used for given load requirements. The motor drive 162 for drive pulley 148 is mounted on one pinching bar 170, as are both bearings for that driveshaft. The compression pulley 152 has its shaft bearings each mounted in a support plate. An end plate 174 keeps both linear mounts stable, as does their attachment to the top of compensator 82.

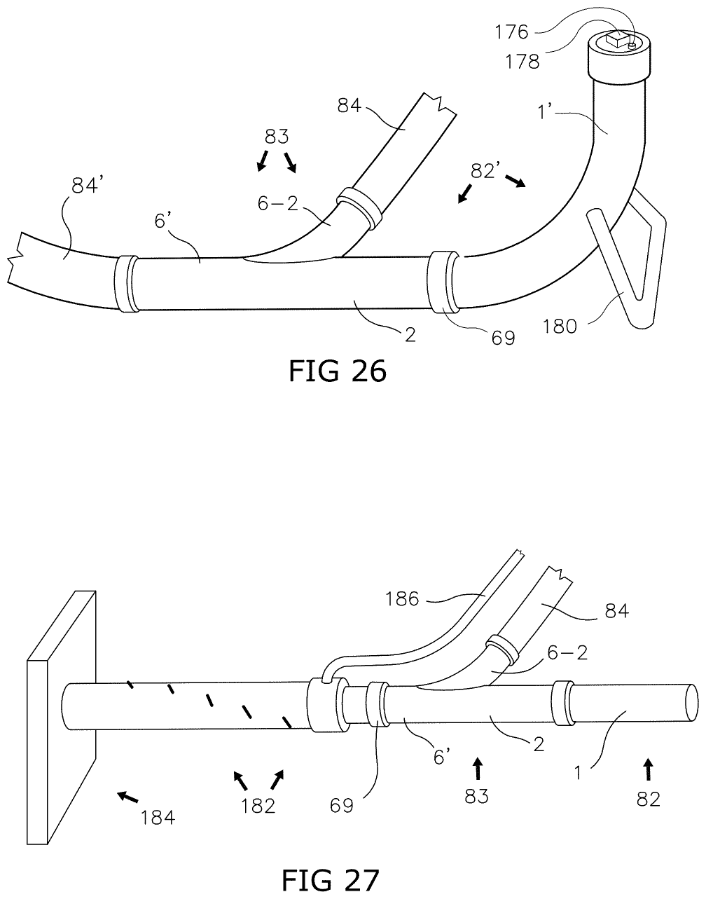

FIG. 26

This figure shows a simple version of a compensator 82′ that utilizes a chamber of compressed air or gas to compensate the pump fluctuations. As this type of embodiment uses a fixed mass of gas for compensation purposes, it is better suited for locations having relatively lower line pressure. Specifics of this type of chamber of gas can be per existing “surge suppressors”, and is not otherwise disclosed here. The surge suppressors are sometimes called T-pipes, regardless of the gas used or the means of holding pressure, consisting of a length of perpendicular pipe in the concrete pump line with a means to hold gas pressure at the dead end. They can include a high-pressure tank of nitrogen gas that can be in communication with the dead, end and utilized to provide a stronger elastic response.

Any of these prior art features, not shown here, can be included with this improved device geometry.

The inescapable problem with existing surge suppressors is that either the withheld concrete cannot get out of them fast enough to compensate for the swing tube crossover, and/or they cannot withhold enough concrete for discharge to compensate for the switchover. These devices are meant only to reduce surging effects on equipment as caused by pumping fluctuations; they are not expected to smooth the concrete flow to an average rate. In contrast, this embodiment shown in FIG. 26, while not sophisticated nor having controlled damping, does provide a strongly preferred direct path for the discharged concrete, relative to the concrete pump line, allowing for a very rapid discharge, a greater volume of withheld concrete, and so a significant performance improvement. This is achieved by having the straight line of compensation from tube 2 to 6′, and preferably that this line is also of a larger diameter than the line 84 and sweep 6-2 coming into it. The cylinder body 1′ is shown as a sweep elbow of pipe, but this can also be a tight elbow where there is enough horizontal length combined with gas pressure and volume adjusted sufficiently high to keep concrete out of the elbow turn itself.

The geometry of the device provides a relatively much faster discharge action for the periods where the pump is switching cylinders, and a relatively slower withdrawal action, simply by the wye 83 geometry. Specifically, as the concrete flowing from line 6-2 into tube 2 must travel around a very acute angle, this geometry slows it movement into tube 2; most available concrete takes the easier path on to line 6′, with variables being the concrete slump and relative pressures at that moment. Then, when tube 2 is discharging, there is no turning angle to slow the concrete, and the path of travel is entirely the larger diameter conduit, so the discharge action occurs much faster. In this way, the wye 83 geometry can allow the best passive response to the piston pump cycle that is possible using only the elastic properties of a sealed chamber of gas.

This passive device provides a substantial improvement to the conventional T-pipe configuration of surge suppressor by its improved geometry having a path of substantially less resistance for the discharge action than for the withdrawal action, providing a more rapid discharge rate than withdrawal rate; in that the concrete movement for the withdrawal action must turn an acute angle, while the concrete movement for the discharge action need only take a slight turn or none at all. This improved geometry alone makes the difference in rates possible because of the characteristic of a fluid such as concrete, in this case having a high volume of solids that resist abrupt changes in direction of flow.

A stand 180 keeps the tube 1′ upright so that gravity keeps concrete stays out of at least the upper portion of it, and so that air does not excessively intermix with concrete. The top has a pressure cap 176, that can simply be a NPT threaded plug or the equivalent, or a plug affixed with an HD flange clamp, etc. A pressure control valve 178 can simply be a Schrader valve or a nipple pressure valve such as is used with high pressure air or gas systems. The components all need to be suitable for the working line pressure, which can exceed 1000 psi or more if near the concrete pump, or at a much lower working pressure if the device is positioned near to the line discharge. The valve 178 can be used for pressure relief for cap 178 removal while concrete is in the line, and for pressure injection of air, or a gas such as nitrogen, if that helps the performance.

FIG. 27

This shows an arrangement where a compensating device 82 and wye junction 83 are attached directly to an inline mixer 182. In this case the mixer is connected directly to a screed panel 184, but this is optional. An admixture injection line 186 connects to the inline mixer. In this case near the discharge, power assistance may be preferable for the compensator withdrawal action, and particularly if the remaining line diameter is increased to assist the inline mixing and machine-controlled placement operations. The inline mixer 182 is one first disclosed in U.S. Patent Application Ser. No. 62/446,444, titled “Methods and Devices to Make Zero-Slump-Pumpable Concrete,” to Michael George BUTLER, filed 15 Jan. 2017; and the screed panel 184 first disclosed in U.S. Patent Application Ser. No. 62/793,868 titled “ADDITIVE LAYERING SYSTEMS FOR CAST-CONCRETE WALLS,” to Michael George BUTLER, filed 17 JAN. 2019.

This shows one example of how the elements disclosed can be beneficially combined. There are countless examples, such as the case where an embodiment utilizing automotive shock absorbers for damping can be combined with any of the means disclosed for an active assist of the discharge.

FIG. 28A

This shows a concrete pumping/boom truck 190 outfitted with an onboard surge compensating system, 82 and 83. This boom truck 190 is shown with a relatively very short boom system 192, in that this one is designed to be used for machine-controlled concrete placement. Even in this application, the boom can be of more segments, only two are drawn for simplicity. The boom is utilizing the placement/screeding device 194, having a screeding panel 184, disclosed in U.S. Patent Application Ser. No. 62/793,868, titled “ADDITIVE LAYERING SYSTEMS FOR CAST-CONCRETE WALLS”, filed Jan. 17, 2019, by this same inventor. In this case, the device 194 shown includes a version of an inline mixer 182, with an admixture pump 89 and that admixture line 186 following the boom, so that intermixing can occur near the point of placement; and two of an onboard external vibrator 185 on the screeding panel 184. The boom 192 and device 194 can include a machine control system to guide concrete placement, with geometry information provided by a digital model, and real-time positioning provided by a total station and gps, for example. A concrete-conveyance pipe 197′ that is typical of following the boom 192, is replaced by a length of hose 84 near the device 194, allowing for its positional corrections. These features can vary considerably.

Independently of any needs for consistent concrete flow facilitating robotic concrete placement, these placement booms are well known to react very strongly to the abrupt pressure variations typical of a piston concrete pumping system. The reaction tends to be pronounced at lower pumping rates and with stiffer concrete mixes, where it is common for the tip of a long boom to fluctuate up to 5 feet vertically during swing-tube switchovers, making concrete placement very wearing on equipment and workers. This phenomenon is the subject of many studies on vibration damping, where complex active counteracting systems are proposed to cancel these boom oscillations. Recent pump design improvements to minimize switchover effects and to minimize pumping surge have helped, but have not solved the problem. If the pumping surges can be eliminated, then the related boom oscillations also disappear. Of course automated concrete placement systems require a steady flow of concrete—which is a higher level of surge compensation, unless extraordinarily difficult and complex robotic motions control systems are designed and employed to start and stop concrete placement movement based on abrupt pumping fluctuations, an infeasible proposal.

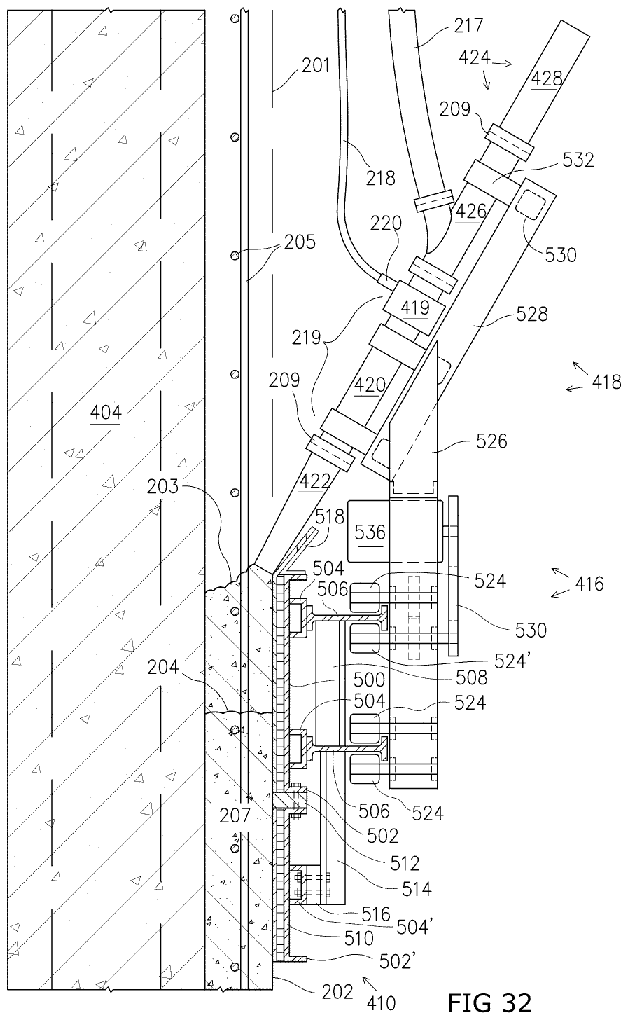

The compensation system shown is adjacent to a discharge line 196, from an onboard pump system 81, that pumps concrete that was previously dispensed into a hopper 195. The geometry shown provides a turn in the line that runs from the discharge 196, to the conveyance pipe 197, allowing the path from the compensator 82 into the pipe 197 to be straight, allowing the improved discharge action discussed previously. A removable pipe plug 87 allows bleeding of air or injection of lubrication of fluid, per FIG. 2. This compensating system can be employed in combination with another like system located at the placement/screeding device 194, such as the flow fluctuation compensator 424 system shown in FIG. 32. The combination of two compensators in one pumping line will be able to deliver a flow rate of concrete that is constant, allowing automated concrete placement under varied line conditions. The compensator at the pump is appropriately tuned to higher pressure and greater fluctuation, while the compensator at the delivery end is appropriately tuned for smoothing out more subtle residual fluctuations, allowing a robotic placement based on a constant flow rate to be employed.

FIG. 28B

This shows another version of the improved compensator geometry onboard a pumping truck. In this case the compensation system is adjacent to the vertical axis of a boom pivot 188, where an elbow 187 connects to a swivel coupler 188. As existing pumping trucks often have the geometry where the supply pipe 197 takes a horizontal bend in order to center the elbow 187 at the pivot 188, it is conducive to substitute the wye 83 having a bend per the leg 6-2 match the original plumbing bend, so that the path from compensator 82 can be preferably straight into the elbow 187—which is required anyway to run the concrete up the boom.

FIG. 28C

This shows an electromagnetically-controlled compensating mechanism 82-2, where the piston 2 motion within cylinder body 1 is provided control by an electromagnetic linear actuating system. A permanent cylindrical magnet 200, with poles at each end of the cylinder, is connected to rod 4, and its position is magnetically manipulated linearly by a linear series of a coil winding 199, each encircling the cylinder housing 216, attached with an electrical isolator 215 and non-conductive non-magnetic fasteners, not shown. Rod 4 can preferably be non-magnetic stainless steel. Housing 216 is not-magnetic material such as aluminum; it can be the cylinder body utilized for pneumatic actuators for example. Housing is well attached to body 1; fastening is not shown here nor at the magnet to rod. Housing has vent openings at both ends and magnet is a loose enough fit to allow unrestricted linear movement, and allows air passage as required. Each of a cylindrical coil 199, wound of insulated copper per state of the art practice, can be activated by a corresponding circuit 198, which is high voltage DC and current applied according to requirements of magnetic actuator design relative to design loads. A power inverter can produce the required DC voltage current from an AC input. This simplified diagram shows only four circuits corresponding to four coils, an actual electromagnetic compensator could have a dozen or more circuits and coils for preferred action. Protective shielding outside of the coils is not shown. The spacing between coils must be sufficient to avoid electrical shorting between them. The spring 5 is not required for this embodiment, however it does lessen the amount of force required of the electromagnetic system, and so is included in this description. The Schrader valve 36 is also not necessary, though it does provide some field adjustment of compensator behavior by adding or removing pressurized air or gas; alternatively the top of body 1 can be open to the atmosphere.

Motion to piston is controlled in withdrawal (upward) by a timing the activation of the coils in the sequence ABCD, where each is attracting the magnet 200 in turn, the withdrawal motion ideally matching the timing of a stroke of the concrete pump piston, so that the chamber 7 withdraws concrete at a constant rate as possible. FIG. 28C shows the withdrawal almost complete, with the current having just switched from coil C to coil D. As the spring 5 is loading up and increasing resistance during withdrawal, while the concrete line pressure is remaining somewhat constant, the preferred effect of the coils in the withdrawal action is to resist withdrawal initially as the spring load is minimal, then to assist withdrawal as the spring resistance increases. The electromagnetic control can largely be utilized to offset the spring loading in withdrawal. Coil D can be kept energized until to withhold the concrete against the force of the spring until the moment for discharge.

Motion to expel concrete back into the line can be initiated by a rapid sequencing of circuits in the sequence CBA. The discharge timing ideally matches the concrete pump switchover. For practical purposes this is often as fast as it is possible to move the concrete, and this is what the electromagnetic actuator can do. For this simplified example, if a particular concrete pump switchover takes 0.24 seconds, then each circuit sequencing would be approximately 0.08 seconds after the previous one. A near simultaneous deactivation of one circuit as the adjacent one is activated, as is the known practice in electromagnetic propulsion systems. Coil A is kept activated long enough to initially resist a too-rapid refilling of chamber 7, and then the withdrawal sequence ABCD is repeated.

For either direction of movement, the polarity of the magnet is best to be aligned with an opposing polarity induced by each coil, so that the magnet position can be attracted by that coil, the magnetic forces pulling the magnet toward a position of alignment with a particular activated coil. The permanent magnet can be augmented or eliminated by use of a coil attached to rod 4, having a polarity that opposes the outer coils 199. This inner coil would be energized by loose flexible well-protected leads that travel within the housing, and lead out the end of housing 216.

All of these sequences and their timing will ideally be tailored to best compensate a given concrete pump, pumping rate, and the concrete mix consistency. For example, most cylinder-switching concrete pumps have a switchover time period that is proportional to the pumping rate, while one manufacturer, Putzmeister, has developed a rapid switchover that is independent of the pumping rate. So for the independent switchover design, the compensator would maintain a constant-rate discharge sequence, while the withdrawal would adjust with the pumping rate. The controlling signals to the coils can be generated from any method disclosed here utilizing the concrete pumping system, or per known practices in the art. Any advance of the signal to the compensator before the concrete pump switchover, as discussed, can be a beneficial characteristic if the signaling system.

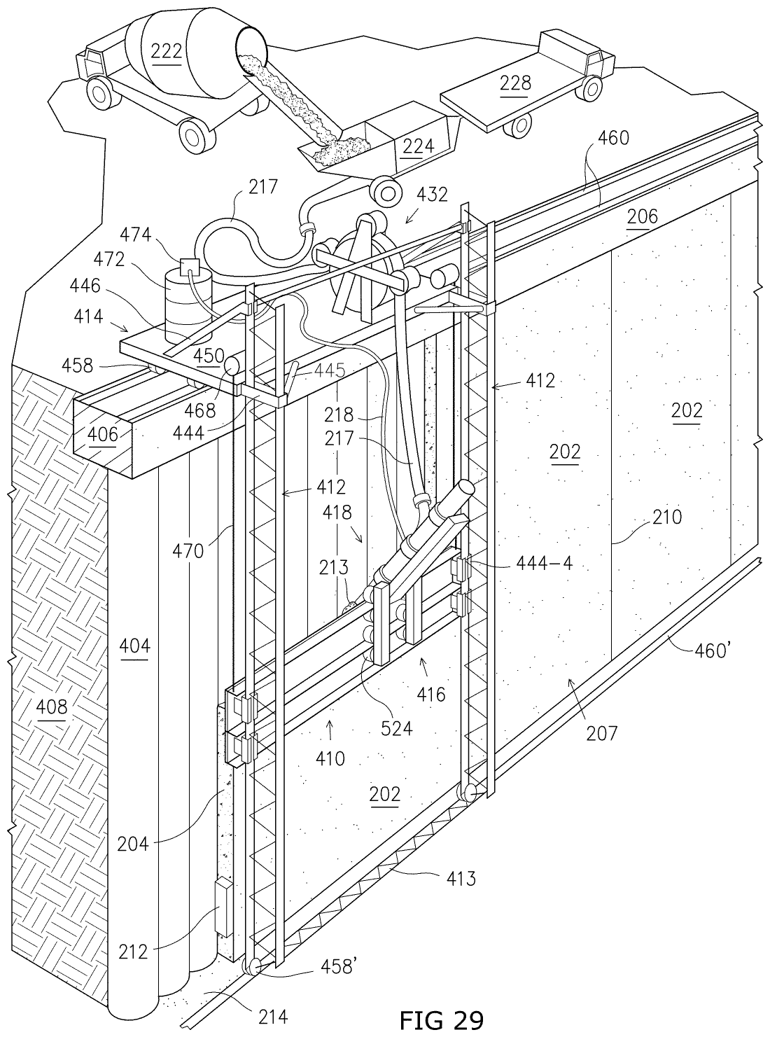

FIG. 29

FIG. 29 shows an operation where a series of pilings, in place to allow a large basement excavation, are getting covered with a concrete wall. It is common for basement foundations of tall buildings sited on soft soils to first have a perimeter basement wall built by excavation, and then concrete placement into the perimeter excavation. In this example, the “secant piling” method is shown, where the result is a series of overlapping cast-concrete pilings that allow the basement excavation to take place. Such basements are commonly many stories deep. The resulting interior surface is very irregular, likely damaged, and certainly dirty. It is common and preferred to then place a new concrete wall over that very rough interior surface in order to have usable, finished basement walls. This example shows one foundation construction method, but the new methods developed are suitable for very rapidly placing a new concrete wall over any vertical or sloped surface.

A series of a cast concrete piling 404, also known as a drilled concrete pier, are in place per the secant piling method, but of course the specific construction method can vary. A concrete piling cap beam 406, which can be the guiding element for drilling the piling excavations, is cast in place along the line of the finished basement wall surface, or roughly parallel to that. The retained soil 408 is shown in a “cut-away” view behind the foundation wall, but the adjacent end piling 404 is shown as a full circumference piling for clarity of its form; it would technically be “cut-away” also, like the cap 406. This view does not show reinforcing members or mesh, nor any dowels or ties into the existing pilings. These things will most often be required, but including them in this drawing made it too cluttered. Two of a guide channel 460 are set along the cap 406, and one lower guide channel 460′ is set along the bottom of the wall. It is assumed that a supporting surface is present, such as a top of a concrete footing 214, or similar. All the channels are set along a predetermined line in order to define a finished wall surface 202. The channels 460 are of a steel channel section of a width to accommodate a guide wheel set 458 and 458′, that will guide the wall creation system.

Two of a vertically oriented guide truss 412 have their horizontal direction of movement controlled by the channels 460 and 460′. Truss 412 is shown of welded steel, with chords of steel tube with a width and stiffness to provide sufficient lateral stability for the long, unbraced span, with lateral-torsional loading. Each truss can alternatively be of a wide flange steel beam. A set of the lower guide wheels 458′ is attached to the bottom of each truss, where that end is stabilized relative to the other truss by a stabilizing truss 413, that removably attaches to each truss chord. This lower translational system can be moved and affixed by conventional means, per methods disclosed further regarding the upper wheel sets 458. The upper portion of each truss 412 is guided by a sliding locator 444. Both locators 444 reference to a control platform 414, the platform 414 having translational movement provided by wheel sets 458 that are guided by the channels 460. Each locator 444 has a brace 245 for torsional stability of the trusses 412. Also shown are two of a chord locator brace 446 that serve to provide end rigidity to each truss.

The platform 414 has controlling systems for the concrete placement operation, and a working deck surface 450, supported by a frame 448. A concrete hose handler 432 provides a means to lower and raise a length of concrete pump hose 217, as needed for concrete placement operations. This device can be avoided with use of cables, disclosed below. An admixture dosing pump 474 and an admixture line 218 are also controlled on platform 414. Two of a lift winch 468 are each positioned to allow a cable 470 to be aligned to lift a large slip screed 410. The slip screed 410 is positioned to screed off a finished concrete surface 202 as it is lifted, with guidance provided by the trusses via at least two of a sliding locator 444-4 that reference the truss chords. This view shows two locators 444-4 per truss chord; other drawings show one. The screed 410 guides the movement of a translational carriage 416, where the translational movement is accomplished with a number of a control roller 524, some of which are motorized and some that are not. The carriage 416 controls positioning of a controlled discharge system 418, which is in this case a combination of devices that provide a smoothed concrete pumping action, with a modified favorable rheology, that allows a very workable concrete to subsequently hold a vertical shape shortly after placement. The concrete being placed 203 is temporarily confined by the screed 410 during placement, until the cables 470 lift it above that portion of concrete wall. No people are required to be present at the concrete placement area; video cameras can transmit feed of the placement progress to operators on the platform 414, and/or the system can be provided with feedback sensors for automated operation. With placement feedback, the placement system can be entirely numerically-controlled, as a planar concrete “printing” gantry for vertical or sloped surfaces, that can “print” regular concrete.

A conventional concrete truck 222, or any other means of providing concrete, can deliver conventional concrete to a concrete pump 224. This can be a conventional trailer piston pump with swing-tube action, or the like. A truck 228 or other means of mobility for the pump is preferred, in that these pumping operations proceed very quickly, and so pump repositioning may be preferable. The pump 224 then delivers the concrete via the hose 217. The pumping rate with this method can be any that is possible with most concrete pumps.

The sequence of concrete placement requires the concrete to be placed from the bottom up, at any location horizontally along the wall. Typically at each position of the trusses 412, the screed 410 will proceed from bottom to top of the wall 207, but the process can stop at a given elevation, to move to an adjacent location, and then later proceed at those locations to the top—if this sequence is beneficial. The new edge of previously placed concrete 204 will define a control joint 210, which can be defined more specifically with a closure strip 212. The strip 212 can be as simple as a board that is positioned and then removed, or it can be a stay-in-place water stop, to prevent future leaks at the joints. Practice has shown that a strip 212 is not required for the concrete to stay in place, but that a straight line for the joint can be defined with a length of piano wire or straight edge, etc, such as is done with shotcrete placement practices.

While FIG. 29 shows a vertical surface with the operational control taking place at the top, the surface can be sloped, such as in lining a concrete canal, in which case the vertical trusses can be considered “upright”. For taller walls, the lower portion can be placed and controlled from the bottom, with guidance for the tops of the vertical trusses be provided along a temporary linear structure attached at a mid-height of the wall surface, for example. The upper portion of that wall can be constructed as depicted here, with that linear structure then used for guiding the bottom ends of the vertical trusses. The geometry control system depicted, including the pair of guide trusses 412 and the large slip screed 410, can of course be duplicated and controlled to define a parallel plane, for in-situ construction of a freestanding concrete wall.

As this concrete placement beneficially take place remotely from the people operating the equipment, the support systems for concrete placement do not have to be designed for the safety of people riding on board, such as is the case with lifting scaffold platforms, etc. To monitor the concrete placement, video systems are required, with those monitors preferably located on the control platform, not shown for clarity. Other relevant concrete placement monitoring systems are disclosed below, but are not shown in FIG. 29.

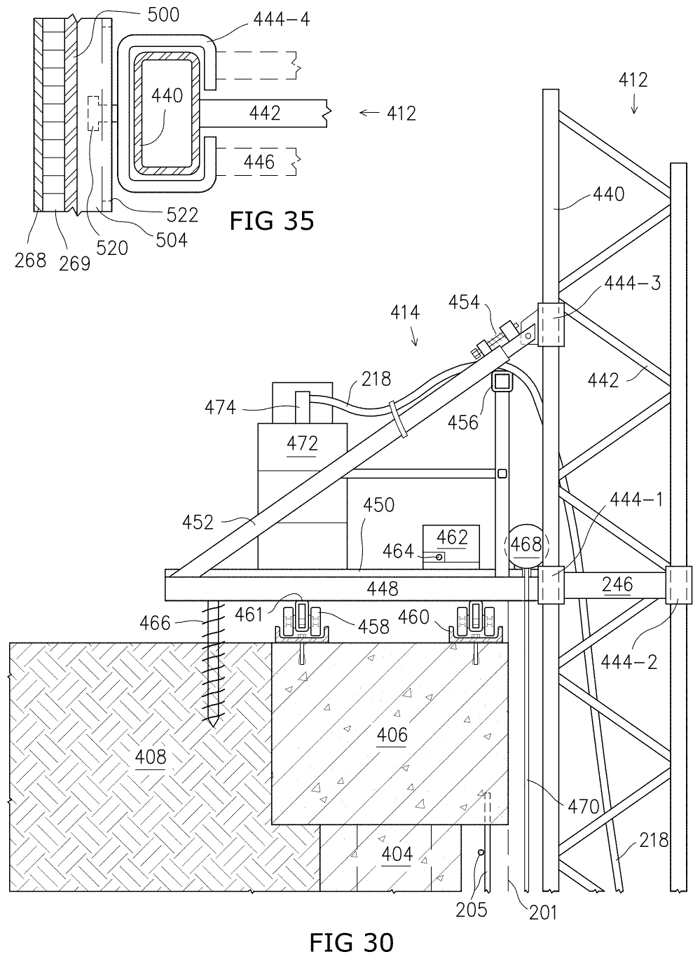

FIG. 30

This is an end view of the control platform 414, showing more detail such as the support of truss 412 at deck level, where a sliding locator 444-1 and a sliding locator 444-2 are connected by two of a chord locator brace 446. Each locator is of a steel tube section that fits freely about the circumference of the truss chord, with clearance up to about ⅛ inch, and each brace 446 is a horizontal steel tube section. The diagonal brace 245 is not shown here. This is a welded assembly that can be welded or bolted to the platform, and it can be the encompassing locator 444 shown on FIG. 29. Another sliding locator 444-3 is supported by the brace 452 with an alignment adjuster 454. Brace 452 is braced laterally by a guardrail 456. The purpose of this assembly is to help stiffen truss 412, but more importantly to stabilize the platform from momentary tilting toward the excavation. The adjustment 454 is necessary to allow for variations of platform support, etc. Truss can be lowered into this assembly by a crane, or the locators can be made to open and then clam about truss chords.

In this case each channel 460 is fixed into alignment on the cap 406 with an expansion bolt or the equivalent. Each would be shimmed for variations in elevation if required. The wheel sets 458 are made to fit in the channel section, each with one wheel each side of a transverse beam 261 of a stout tube-steel section—two of which serve to support the deck control frame. Translational motion to platform 414 can be accomplished with a winch 462 and a cable 464 with an end attached to a fixed object, or a motorized wheel can be used, or a vehicle can move it. The platform can be fixed into place with a clamping brake on at least 2 wheels, or an auger anchor 466 can be employed—which also serves to stabilize the platform.

A rheology-modifying admixture is shown in a drum 472, or an equivalent container, on the deck surface 450, with the admixture dosing pump 474 attached. The admixture line 218 can be the hose and connection type used for airless paint spraying, for example. The handing of this type of lightweight hose is a minor issue. The lifting cable 470 can run through a hole in the deck. The lifting winch 468 is an electric hoist of suitable size that clamps the cable when not running

Each truss chord 440 is fairly heavy and wide, to provide stability for the unbraced longer span with side loading included, such as a 6″×2″× 3/16″ steel tube section. Each web member 442 is shown welded on; these can be relatively light, such as 1.25″ schedule 40 pipe, or lighter, with appropriate spacings. Alternatively, the vertical trusses can be 3-chorded “space trusses”, avoiding concerns about lateral-torsional bending stability and related bracing shown at support locations.

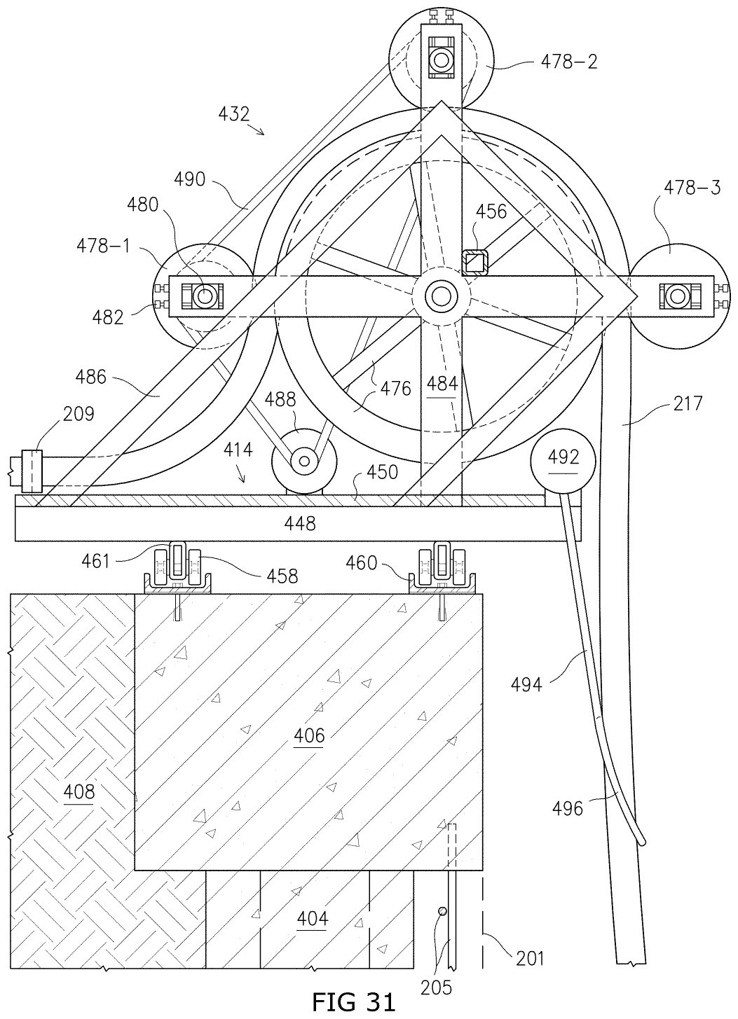

FIG. 31

This shows a face view of the concrete hose handler 432, one option for dealing with a very heavy concrete hose that is draped down a tall basement wall. The concrete hose wheel 476 is sized for the minimum bend radius of the concrete hose being used. For example, 2.5 inch hose can have a bend radius as small as 14 inches, but of course this depends on the hose manufacturing. The length of a hose section used here should exceed the wall height, so that a coupling connection 9 does not have to run through the handler 432. To control the hose extension into the basement, a number of a hose drive pulley 478 is used. Each of the array of pulleys is supported by a length of a steel tube member, such as 484, each sized appropriately, with each of that set of members braced by a brace tube 486. Pulley 478-1 and 478-2 are driven with a belt 490 that runs to a drive pulley at a motor 488. Pulley 478-3 is freewheeling; its primary purpose is to keep the hose onto the wheel 476 at the hose travels from side to side. All the surfaces controlling the hose are made concave to minimize a pinching action that could block concrete flow. Each wheel 478 has an adjustable bearing plate 480 on each side, so that the compression onto the hose can be optimized—adjusted with a pair of a locking screw 482, and so that the gap can be opened allowing the hose end flange fittings to fit between pulleys 478 and wheel 476. During the pumping operation the hose is primarily wheeled upward, so that a pinching action between pulley 478-1 and deck 450 is minimized Alternatively, the hose 217 can be lifted with a hose sling 496 at a cable 494 and winch 492, or this can be a temporary holding device while adjustments are being made to the handler 432.

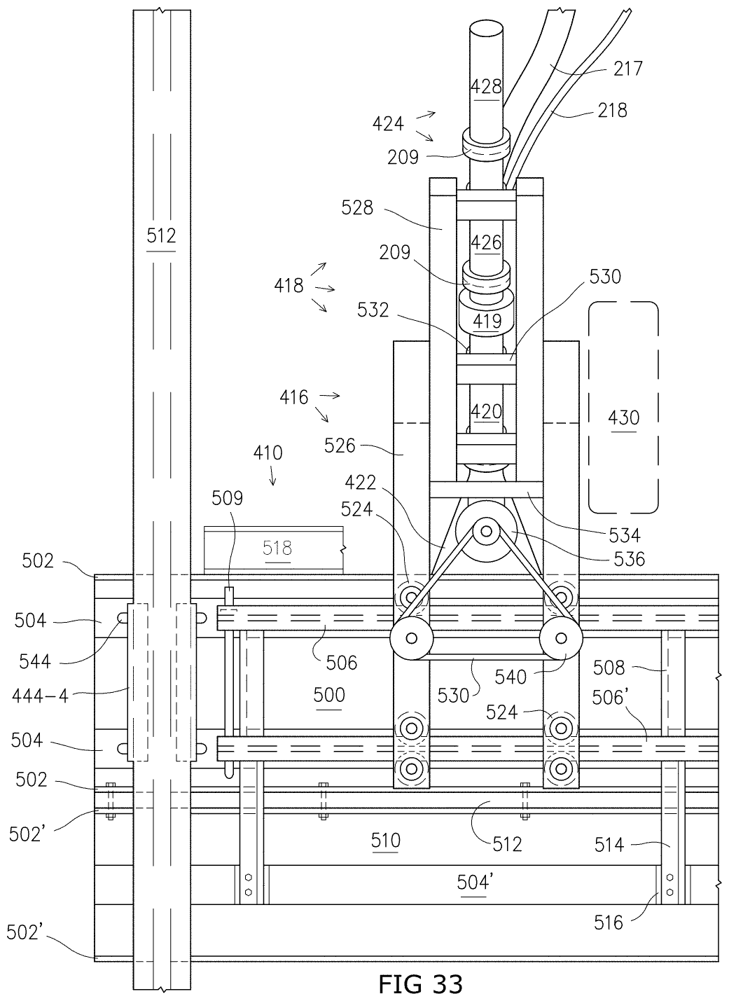

FIGS. 32 and 33

FIG. 32 is a side view of the translational carriage 416 supporting the controlled discharge system 418, and a section view of the large slip screed 410. FIG. 33 is a back-face view. This embodiment of carriage 416 has a main structure that is two of an upright tube 526 that each connect to two a sloped tube 528, and those interconnect with a series of a connecting brace 530. A number of a band 532 attach a flow fluctuation compensator 424, one of any of the embodiments of patent application Ser. No. 62/830,445, and any embodiment of an inline mixer 219 of patent application Ser. No. 62/446,444, both of this same inventor. The compensator 424 is not required for the present application, but the steady concrete flow rate and lack of surging is highly beneficial; it can be any version of the compensating mechanism 82 combined with any version of the wye junction 83, disclosed in FIGS. 1 through 28. In this embodiment, it consists of a modified wye 426 and a compensating mechanism 428 behind it, which can be attached by the coupling shown or by bolted flanges. Any lines for power or hydraulic or power that may be required for an active embodiment of the compensator 424 are not shown here. A smoother operation of the placement system is possible with an additional compensating mechanism at the concrete pump discharge. The inline mixer 219 allows a rapid vertical buildup using normal concrete material. It consists of an injection plenum 419 that connects to the admixture line with a check valve 220—to prevent cement from backing into the plenum. The mixing chamber 420 is enhanced to allow thorough intermixing of the concrete and admixture before leaving the aspect shaping nozzle 422. The nozzle 422 presents a narrower flow section in one direction and a much widened in the other, so that a larger orifice is possible with less interference with the reinforcing bars 205, allowing faster placement of concrete. The rapid change in nozzle 422 aspect in flow section helps complete the concrete/admixture intermixing.

This version of the large slip screed 410 has 2 main parts, each a steel channel section that is vibrationally isolated from the other. The upper one consists of a screed beam web 500 and two of a flange 502, and the lower one consists of an isolated beam web 510 with two of a flange 502′. Each web has an active non-stick surface system at the concrete surface interface per patent applications referenced above and as improved following in this disclosure. The backside of the web 500 has two of a beam reinforcing channel 504 and two of an I-beam roller guide 506 welded on. The I-beams are the main element of strength for the span of the screed under load of consolidating the concrete, in combination with the other members through composite action. These strengthening I-beams are stabilized with a series of a stabilizer 508, installed as needed to also provide torsional strength to the screed 410.

Also, a series of a support brace 514 are welded to the lower I-beam 506 for support of the lower channel web 510. All connections to that lower portion are vibrationally isolated as practical, by use of an isolation pad 516 at bolted connections to the lower reinforcing channel 504′. The continuous connection is isolated with a continuous isolation strip 512 between the upper and lower portions. The reason for the isolation is to allow vibrational consolidation of concrete adjacent to the upper portion, while the concrete below the lower portion is not affected by vibration. The isolation material can be a dense foam rubber, such as a Durometer Shore A 10 rubber.

The web of each I-beam 506 is used as a supporting surface for opposing pairs of the rollers 524. The rollers are of a urethane material such as is used for contemporary skateboard wheels, such as urethane of Durometer Shore A 80, though at least the drive rollers 524′ will need to have a keyed shaft with sets of bearings at tube 526 (as drawn for all rollers), to allow torsional drive from a motor 536 via a drive belt 538 and a set of a pulley 540. The motor 536 can be attached to a motor brace 536, that also connects two a chamfer strip 318, can be fastened along the top of the uppermost flange, so that over filling the confined space with concrete does not end up in the upper I-beam web.

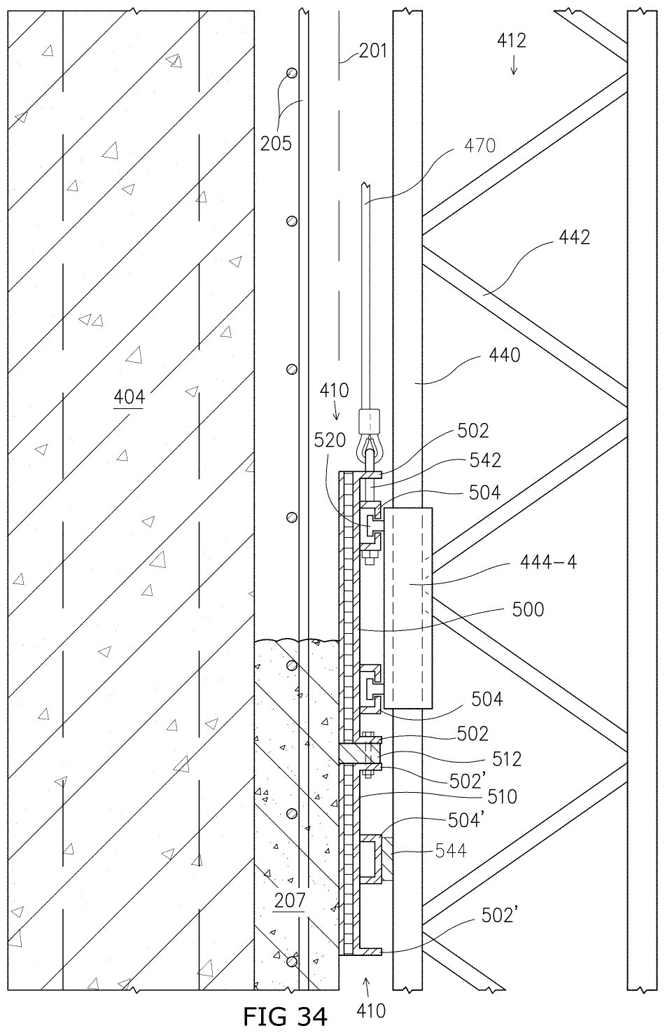

FIG. 33 shows more things than FIG. 32, such as: One truss 412 and a sliding locator 444-4, which is shown more clearly in FIGS. 34 and 35. The ends of a slot 522, for attachment of the locator, can be seen on channel 504 either side of the truss 412. Each channel 504 continues to each end of screed 410, but the I-beams 506 stop short enough to allow passage of the truss 412, so that vertical support of the screed can be close to the centerline of its mass. An actuated vibrator 430 is represented by a rectangle. This can be any embodiment of the patent application Ser. No. 62/793,868 and PCT/US2020/014215 by this same inventor. A vibrator 430 can be on each of carriage 418, so that one is helping placement and the one following is improving consolidation. The upper portion of the screed 410 can also have vibrational elements attached, of low enough amplitude that the lower isolated portion is not causing concrete to slump out of plane. FIG. 33 does not show the reinforcing bars 205 that you see in FIG. 32, for clarity.

FIG. 34

This is a section view of the screed 410 showing more detail of the supporting connections. The lifting cable 470 connects to a U-bolt 542, or the equivalent. The wire eye could have a shackle. Each channel 504 at web 500 has the slot 522 for the headed stud 520. The horizontal length of slot 522 allows some slope to screed 410, etc, as this action can be preferable in that a slope to the screed can improve concrete placement. Meanwhile the wall plane can be defined, within allowable design tolerances. A shim 544 can be attached to the back of channel 504′ where it intersects the truss chord, for more direct support.

FIG. 35

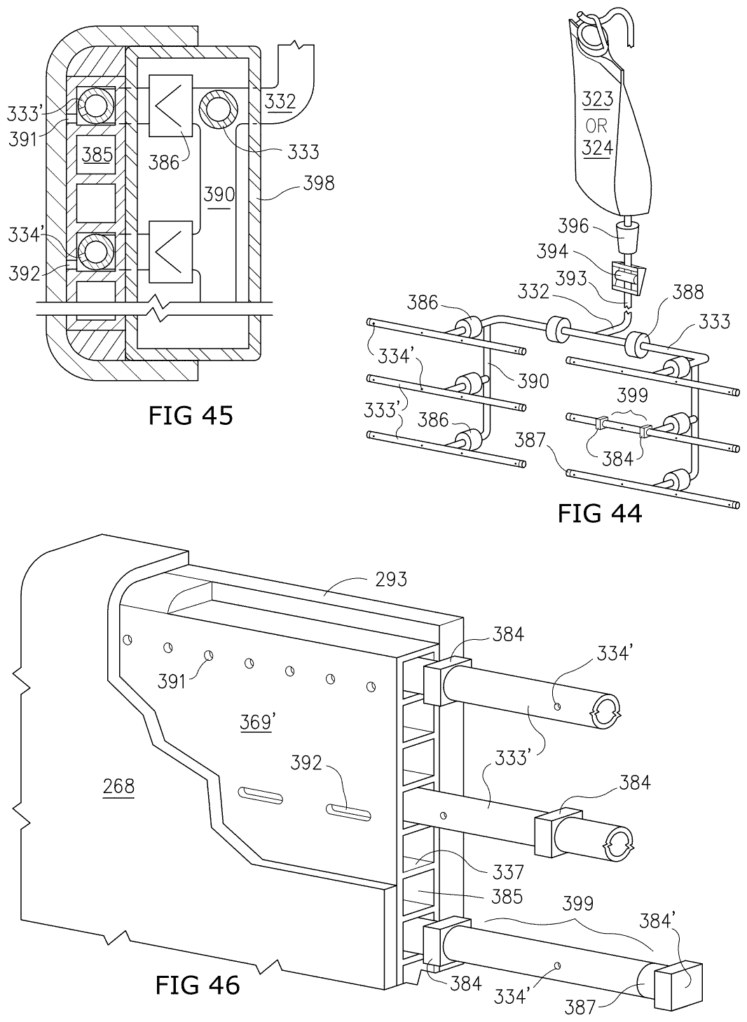

This shows a section of the truss chord 440 near a locator 444-4, showing the slot allowing passage by the truss webs 442, and the headed stud 520 though the channel 504. The active non-stick surface elements on web 500 consist of a cellular chamber 269 and a permeable non-stick cladding. These are disclosed more at FIGS. 44, 45, and 46.

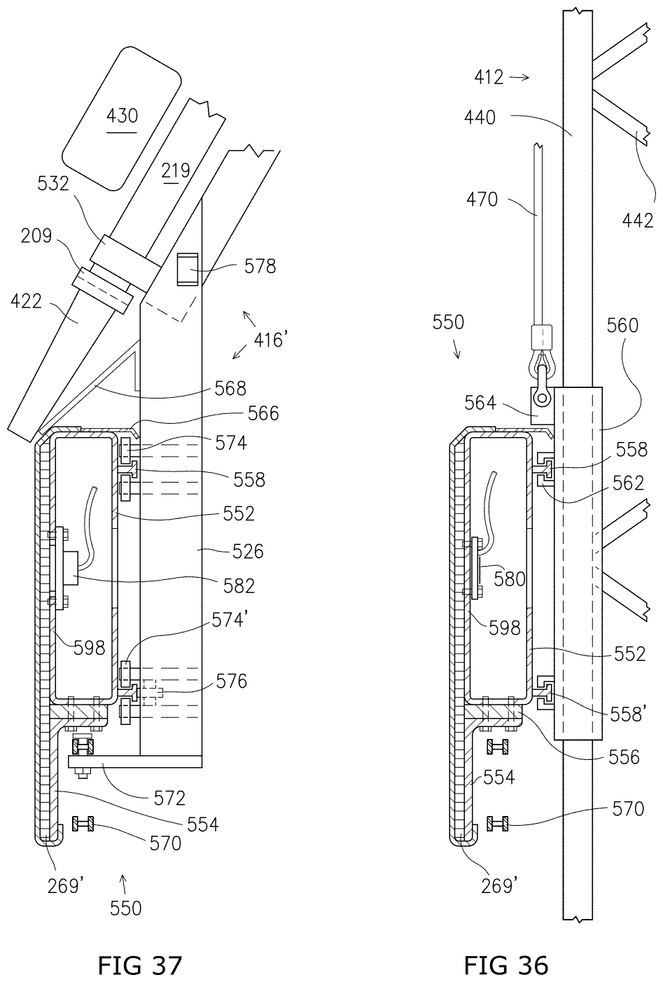

FIGS. 36, 37 and 38 Overview

These drawings show a tube screed 550, which is a version of a slip screed where the guide truss 412 can provide alignment at any point along the length of the screed. This is accomplished where two of a tee guide 558 runs the length of a tube beam 552, where the guides serve a dual purpose of guiding the screed 550 and guiding the carriage 416′. Tube beam is a steel tube section, such as 16″×4″×¼″, but of course the beam section depends upon the anticipated span, etc. This design allows a narrower than normal section of wall to be concreted, where the screed can cantilever a random distance past one edge of that wall section. Also, this design allows the screed to be shifted horizontally in order to avoid interference with obstructions projecting from the finished wall surface, and even a third guide truss 412 can be employed for this purpose, if required. These figures also show a variation for a lower isolated portion of the beam that is a cantilevered edge 554, of a length of steel angle, such as 6″×3.5″× 5/16″, bolted to the tube beam 552 through an isolation strip 556, that is of a thickness in the range of ½″ and of relatively harder rubber, in the range of Shore A Durometer 60.

This screed system also shows a variation of elements that allow automated operation and digital control of concrete placement. A series of sensors provide concrete placement feedback by measuring the fluid pressure of the concrete at the point of placement, so that the travel rates of the relevant parts can be controlled appropriately. This variation also shows a chain drive as is typical of a large digitally controlled gantry system, where a motor mounted on one end of the screed controls the concrete placement system position. This system allows digitally-controlled construction of a vertical or sloped concrete wall having a consistent smooth surface.

FIG. 36

This is a section of the screed 550 near a guide truss 412, showing a sliding locator 560 that connects to the lifting cable 470 with a lifting plate 564. With this geometry, the screed can be shifted laterally while support is provided at a location on the control platform that aligns with the guide truss 412, in that a pair of a guide clip 562 is of a length allowing the lateral movement while providing vertical support of the tube screed 550. This arrangement allows the screed to be shifted laterally to avoid obstacles projecting beyond the outer face of the concrete wall, and then to be shifted back again as needed.

For measurement of the concrete placement pressure, a series of a strain gauge assembly 580 are installed along the supporting face 598 of the tube 552. This assembly 580 is installed to measure the strain as placed fluid concrete pressure flexes the face 598 inward between the top and bottom edges. As it is difficult to properly adhere a strain gauge to the inside surface of the tube 552, and to replace one later on, the assembly 580 consists of a strain gauge adhered to a steel plate that is securely fastened, top and bottom, to corresponding portions of the face 598. Machine screws are threaded into appropriately threaded receivers of the face 598, with an epoxy such as Loc-Tite removable thread locking compound, so that the plate of the assembly 580 will strain as the face 598 strains from the force of the fluid concrete. The strain gauge sensor can be one that is linear, of 120 ohm resistance, such as an Omega brand model KFH-03-120-C1-11L1M2R—having a 0.3 mm measurement grid. The strain gauge is installed oriented vertically, with an adhesive such as the Omega SG-401, an ethyl-based cyanoacrylate. Each strain gauge is wired to a data collection system described below, and an excitation voltage is supplied to each strain gauge, according to the manufacturer. This is usually coincident with the data wires, and all are typically shielded cable to avoid false readings.

FIG. 37

This shows the tube screed 550 near the carriage 416′, showing the guidance it on the upper tee guide 558 and lower tee guide 558′ by sets of roller bearings. Each tee must be stiff enough for the prying load of the carriage and the weight of the screed and carriage at each sliding locator 560 support (FIG. 36), so the tee stem should be in the range of ⅜″ thickness minimum, with continuous welding top and bottom, though of a staggered sequence to avoid distortion. The upper tee 558 guides roller bearings 574 above and below its stem, set to act as wheels. These bearings must have thrust bearing ability for eccentric loading and lateral loading, and so are spherical bearing design, or one of equivalent normal and thrust capacity. The means to clip the bearings onto the fixed shaft shown must be designed for the thrust loads. To help isolate the vibrations from the actuated vibrator 430 affixed to the carriage, these roller bearings can be small urethane wheels such as are disclosed at FIGS. 32 and 33.

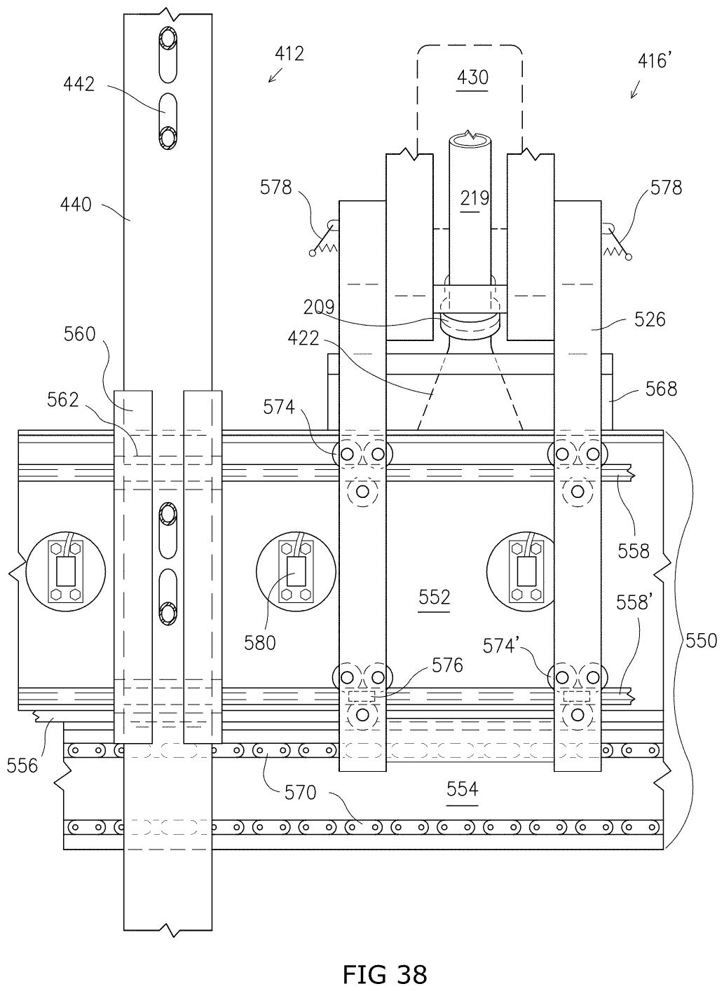

Please see that FIG. 38 shows double bearings above the tees and single below, as the ones above the tee take the gravity load. The bearing below the tee stem can be a thrust bearing. The arrangement of bearings at the lower tee 558′ is one where they do not need to take a thrust load, as a horizontal bearing 576, that runs along the center of the tee flange, takes the result of the eccentric gravity loading. In this case, the roller bearings 574′ above and below the tee stem, can be of needle or conventional ball bearings.

The carriage 416′ is moved laterally by the chain 570, connected elsewhere to a sprocket controlled by a stepper or servo motor, not shown here, or it can be a rack and pinion drive. The chain connects to the carriage with a chain clamp 572 at each upright tube 526. This connection can be any suitable for chain drive, and the chain can be replaced with cable where it would not reach the drive sprocket. The chain material can be any synthetic substitute as is used with controlled motion gantry systems. To avoid concrete spilling over the mechanized side of the tube screed 550, a carriage apron 568 can be employed; it is of a length needed to prevent concrete spillage. In lieu of the chamfer strip 518 that attaches essentially all along the screed (FIGS. 32 and 33), the apron 568 attaches to the carriage 416 and so moves with it. The tube screed 550 is also served by a continuous shield 566 for keeping concrete spillage off of carriage mechanisms. An actuated vibrator 430 is represented by a rectangle. This is any embodiment of the patent application Ser. No. 62/793,868. It can be mounted in line with the concrete placement device.

A load cell 582 is shown in lieu of the strain gauge 580. This arrangement allows a more localized and sensitive measurement of pressure, in that a portion of the supporting face 598 is removed, and in its place is positioned a steel plate attached to the load cell. Pressure against the cellular chamber 269′ is read by the load cell 582. The cellular chamber 269′ material can be 12 mm polycarbonate “Polygal” or the like, so will strain out of plane for direct load cell measurement.

FIG. 38

This shows the rear face of the same elements just described, with the guide truss 412 cut through the web members 442. The reference numerals not referred to here can be identified per the other drawings. The strain gauges 580 are arrayed along the tube 552 at regular intervals, such as 12 inches on center, with access holes provided at the back face of the tube, for installation and replacement of any of them. It is helpful to have flexibility is determining the locations of the strain gauges, so that additional access holes and threaded connections for installation of additional future gauges can be very beneficial.

A limit switch 578 is provided at each side of carriage 416′, to stop and reverse the its motion, etc, by sending a signal to the controlling system, described below. Each switch is shown here high on the upright tube to utilize the truss chord 440 as the physical object to initiate the change, though the limit switches can be lower and a stop device can be attached at any preferred location along the screed.

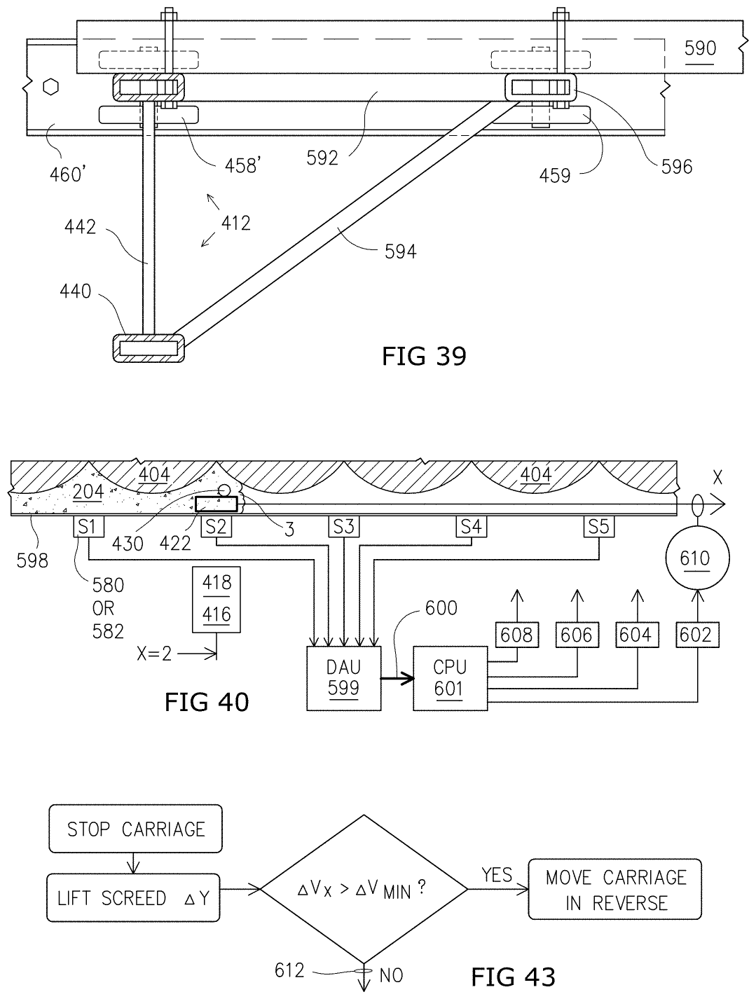

FIG. 39

This shows a system for stabilizing the bottom end of each guide truss 412 without the need for the stabilizing truss 413 (FIG. 29), where the distance between two guide trusses may need to vary, or a third guide truss may be required for working the screed around a vertical obstruction to the finished wall surface. This system uses another wheel set 259 that also follows the channel 460′. These wheels attach to an axle at a chord stub 596, which attaches to the inner truss chord with a strut 592 and to the outer truss chord with a brace 594. These elements all attach to a collocating beam 590, which provides the same purpose as the stabilizing truss 413 (FIG. 29), while allowing a bolted connection to collocating beam 590 of varied distances between the guide trusses 412. The strut 592 is not purely a strut as it also provides a fixed connection for stability of the chord stub 596.

FIG. 40

This is a simplified schematic of a pressure-controlled linear motion system, showing the placement nozzle 422, the concrete being placed 203, and the previously placed concrete 204 between the pilings 404 and the face 598 of the screed. This concrete placement system will make constant corrections to the rate of travel of the placement system, so making compensations to allow a consistent placement of concrete by automation, based on the consolidation pressure exerted. The carriage will continue from one station the next station—only 5 stations shown in this diagram—only if the concrete placement pressure at each given station is high enough to indicate sufficient placement volume and consolidation. Automatically correcting the concrete placement rate to control placement volume is the more complex problem, in that multiple systems are required to be controlled at least to some degree; and the thickness of the placed concrete may vary due to many reasons, and this affects the required placement travel rate relative to the concrete pumping rate. This pressure-reading system can be used to determine that a sufficient volume of concrete is placed at any location, for a condition or a concrete mix that does not require vibrational consolidation. For the zero-slump mix, vibrational consolidation is preferable, and in that case the consolidation can rely solely on controlling the amount of vibration. Intense vibrational consolidation in this area of temporary confinement provides the best quality placement, and there is a close correlation between pressure reading and placement consolidation, so this is a reliable feedback loop to use for an automated placement system.

The sensors, S1 through S5 in this schematic, are typically strain gauges, preferably at each valley of the intersecting pilings, which is ideal for measuring the concrete pressure at the most relevant locations. The irregular surface may be that of an excavated earth surface, etc, so the sensors may or may not be at ideal locations. This feedback system works regardless, however if the aggregate size is very large relative to the wall thickness, a false positive reading is possible at thinner parts of the wall.

The sensors send a signal to a data acquisition unit 599. This can be an instruNet i555 of GW Instruments, Inc. at 24 Spice St #301, Charlestown, Mass. 02129, USA. This type of unit can take raw data, such as very small changes in voltages from strain gauges, and delivers a processed signal 600 to a CPU 601 it for Windows based software to analyze, for example, and in this case for digital control of concrete placement systems. The CPU delivers digital signals to an electronic signal processor 602 for controlling a motor 610. If the operations involve simple on/off motions to the motor, then 602 needs to be a signal processor for a solenoid switch powering the motor and its direction of movement, but if movement control of the motor is to be controlled by digital processing, then 602 is a driver for that control, and the motor 610 must be a stepper or servo motor. In any case, the motor 610 must be a reversible one that controls the X axis movement of the carriage 416 and placement system 418, and if it is a conventional motor, the appropriate gear reduction is required for the required rate of travel for carriage. A 3-phase motor with a variable frequency drive is suitable for this motor 610 to power the carriage motion.

The CPU also delivers signals to an electronic signal processor 604 that controls a solenoid switch to power the actuated vibrator 430′, and a signal to an electronic signal processor 606 that controls solenoid switches to the material pumps (this may be two processors), and a signal to an electronic signal processor 608 that control the lift winches 468 to raise the screed for placing the next layer of concrete (Y axis). Like the motor 610, if the winch 468 (FIG. 29) motions are electronically controlled, then 608 would be a corresponding driver, and one would be required for each winch.

This shows the concrete placement adjacent to Sensor 2, which can be equivalent to a value of 2 at the X axis, for convenience. In this case, the carriage will be stopped at this location if the S2 signal does not indicate sufficient pressure, where the position of carriage, X, is at the value of 2. To allow for an uninterrupted motion of the carriage, the sampling for sensor S2 at X=2 can begin at X=1.9 and continue until X=2.3, for example, before a pause loop is initiated to provide more concrete placement pressure before the carriage is allowed to continue to X=3. The sequential logic for this control system follows.

The positioning of the control system components is beneficial where the CPU and the DAU are both located in a protective enclosure on the control platform 414 of FIG. 29. This includes a display for the system monitoring, along with video monitors of the relevant operations. This arrangement requires that the raw signals from all sensors travel a long distance through ground-shielded cables, and that the DAU is shielded from the CPU and other sources of electrical interference. It is preferable that the motor drivers are also located on the control platform, and for the pump and hoist controls, this is appropriate. In the case of the carriage motor 610, that driver 602 may need to be also located on the screed to avoid an excessive length of cable for that digital signal. Of course the communication with any moving part can be by a wireless system.

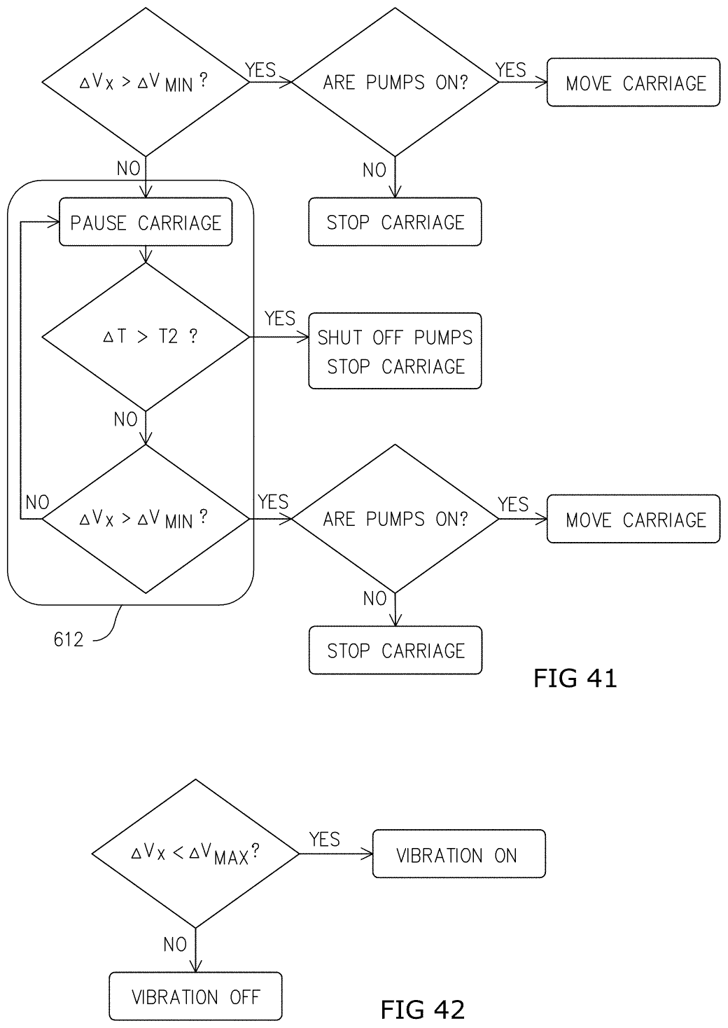

FIG. 41

This shows a logical sequence for the system controlling the X axis of concrete placement—the movement of the carriage along the screed. The decision is based on the signal sent from the sensor within a range of proximity of the carriage, noted above. This range can be modified on the job to suit conditions.

This diagram refers to values of delta V rather than a particular pressure. This is because the strain gauges indicate strain by a change in resistance to a supplied excitation voltage. In this case the gauges are at the tension side of the face 598 flexure, so the more strain from concrete pressure, the lower the returned voltage relative to an indexed value for V. This is the delta V indicated on the chart. The indexed value of V can be set to the value at a given sensor at a given time period before the carriage arrives. The index value for any of the sensors may change frequently during a given job. The value for delta V, relative to an index value, can be a chosen value for any project, and adjusted as work progresses, based on results. The delta V value can be individual to each sensor, based on the subtleties of geometry for each sensor installation. A standard pressure setup can be established as a reference benchmark, using a clay slurry of known density, for sensor calibration and establishment of a default delta V minimum.

A pause loop 612 is where the carriage is paused until the concrete pressure is sufficient to continue moving. As concrete is discharging during this time, it will quickly over flow the top of the screed unless the carriage starts moving, or the concrete flow is stopped. Accordingly, the timeout duration, T2, can be in the range of 3 seconds. The sampling rate for each channel of a data acquisition unit such as the i555 noted, would be in the range of at least 30 times per second per channel, so in this case, loop 612 would run at least 90 times before it times out, however if the sampling period occurs while the carriage is moving over a defined range adjacent to the sensor, the carriage will not need to pause when placement is working correctly. If the timeout has run out, the CPU sends a signal to shut off the concrete pump and the admixture pump simultaneously. And if the pumps are to be stopped, the carriage motion would be stopped in a mode to where it must be manually restarted in conjunction with restarting the pumps.

The logical control system shown here is a very simple one where the decision is basically a go/no-go decision. A preferable control system is one where the rate of travel is slowed to allow the concrete pressure to reach a minimum, before any decision is initiated to stop. In this case, the pause loop 612 is replaced by a reduce speed loop. The reduce speed loop can run over an extended distance, such as between X−0.3 to X+0.5, where over this distance the carriage runs at a lower speed until the pressure increases. The CPU software will indicate to the operator how frequently this happens, so that the chosen rate of travel and/or concrete pump rate can be adjusted to improve the placement process. This rate of travel control requires that motor 610 be a stepper or servo motor, and processor 602 be the appropriate driver.

FIG. 42

This figure diagrams a very simple routine for making a decision about activating a concrete vibrator, based on a preferred maximum pressure, corresponding to a signal of delta V maximum. This is simply a means to prevent unnecessary over vibration of the concrete. This value can be determined according to the method of delta V minimum, above.

For the condition where the delta V minimum is not reached even after the carriage has paused, and then the concrete pumping has stopped, the vibration will be instructed to continue and so will consolidate and continue that pressure gain, unless there is a shortage of concrete discharged. This can be due to a lack of concrete in the pump line, or a larger than usual void to fill with concrete at a particular location, etc. For eventualities such as this, a closed circuit video system is necessary to avoid the need for personnel to make a difficult trip to the placement site. An operator on the control platform will then be able see that the concrete and admixture pumps can simply be started up and the logical sequences initiated just as when the process is started.

FIG. 43

When the carriage trips the limit switch, this chart shows actions taken and a decision to be made before moving the carriage back in the opposite direction. This system will work with a conventional reversible motor 610. As long as the concrete pressure is not up to a minimum, this action will follow the same pause loop 612 of FIG. 13, except that the time of the pause may vary due to the circumstances of the screed moving and the carriage not moving right before this point. Of course, this control goes to the hoists; and as these are much slower than the carriage movement, this time period for pause will preferably be shorter before the carriage is allowed to proceed in the reverse direction.

FIGS. 44, 45 and 46

These show details of improvements to an active non-stick surface system disclosed in provisional applications Ser. Nos. 62/793,868 and 62/793,868 by this same inventor. This system provides a fluid boundary layer onto the fresh concrete surface, allowing screeding, surface manipulation and smoothing of a very sticky concrete mixture that has a tendency to stick to any dry surface, including non-stick materials. The system also provides a means to apply an evaporation retarder and/or curing agent to exposed surfaces of fresh concrete as it is being placed, provided these components are included in the fluid. Shown is a fluid distribution system where the cellular chamber 269′ has an orientation creating a series of a horizontal cell 385. Into each cell 385 is a length of feeder-tubing-including-emitters 333′, used for controlling liquid flow rate from each of an emitter 334′. That is, the tube 333′ can be the type used for drip irrigation systems. An example is the ¼″ diameter “DIG” brand polyethylene drip line, with 0.5 gallon-per-hour emitters 334′, at six inches on center. In this case, a length of the tubing 333′ is positioned into a cell 385 to irrigate that cell at a maximum rate as controlled by the emitters 334′. This can be repeated at cell intervals vertically, as is needed to provide sufficient liquid to the permeable cladding 268. In some embodiments, such as those devices primarily using an upward screeding motion, the lower portion of the screed can avoid the fluid distribution system, where gravity will maintain a fluid layer of the surface. Each cell 385 containing a length of tubing 333′ will have a series of a perforation hole 391 or perforation slot 392 to allow the liquid to flow through cladding 268, an abrasive-resistant filtering material having a network of pores designed for that purpose. These perforations 391 and 392 are not intended to control flow rate; they are to allow liquid collected to evacuate the cell, and so are preferably located near to the bottom portion of the cell.

FIG. 44

This shows an example of a fluid distribution system. Shown is a source of fluid, which can be a gravity feed bag 323, or another liquid source 324 such as a pressurized water line with a regulator. In the case shown, the fluid flow rate can be controlled by a roller valve 394, and observed with a drip gauge 396, as are used with gravity feeding devices. A controlled liquid supply line 393 runs to a screeding device or such tool for manipulating cement mixes, where a liquid inlet 332 connects to at least one feeder tube 333. These lines can all be flexible polyethylene or vinyl tubing or similar. Further control of flow rate to each line 333 can be made with use of an inline emitter 388, such as is used to control branches of drip irrigation systems; and in this case they should typically be at the high end of inline emitter rates, such as at least 2 gallons-per-hour. The feeder 333 can branch down using a vertical manifold 390 or connect directly to a length of tubing with emitters 333′. The purpose of each manifold 390 is to connect the fluid flow to an array of the lines 333′, spaced as needed. These tubing connections can be made with barbed tee fittings, such as are used with drip irrigation systems (not shown due to scale). The ends of each line are capped with a similar end plug 387.

The preferred emitter rate would depend upon how frequent the emitters were placed over a given surface area. One preferred arrangement for a screed generally moving vertically, is where one to three rows of the tubing with emitters 333′, where emitters are spaced at 6″ each tube, are concentrated across the upper portion of a screed, within the upper two inches for example. In this case, emitters rated at 0.5 gallons per hour, or higher, are suitable, as any excess fluid will migrate down the remainder of the screed.

To maintain control of flow rate based on a liquid supply rate, rather than only controlling discharge rate, it is necessary to have a check valve 386 where any emitter 334′ may be significantly higher than another emitter 334′. This prevents a reverse flow created when differences in head pressure cause a higher emitter to let in air, to feed liquid flow to a lower emitter. With the check valves 386 in place at each level, the manifold cannot become a conduit for unwanted back flow. The check valve can be the type utilized for preventing unwanted leakage of drip irrigation systems, for preventing backflow of medical devices, or one of those for preventing water intrusion into aquarium air pumps. Even if fluid flow is typically controlled by discharge rates, the check valves prevent any unwanted air from entering the fluid control system when the screed is tilted, for example.

FIGS. 45 and 46

As the device, such as a tube beam 398, backing plate 293, or large screed of FIG. 29, containing this liquid distribution system may not always be oriented level (horizontal), the same backflow effect can occur between separate emitters 334′ where one is significantly above another, also any such slope will cause the liquid that has collected inside the corresponding cell 385 (defined by a pair of a cell web 337) to run to the downslope end of that cell, and so not distribute evenly over cladding 268. To prevent this, a series of a filler block 384 is inserted over tubing 333′ and inside cell 385, so creating a low-pressure seal. A mini chamber 399 is created between each set of the filler blocks. With emitters 334′ at six inches on center, a series of mini chambers 399 will be at that same spacing, so controlling the liquid flow distribution accordingly when the cells 385 are sloped. Locating orifices 391 and 392 at the bottom edge of each cell will help prevent liquid from collecting at either end of each mini chamber 399. As this fluid distribution system includes many small orifices etc, the fluid introduced should be filtered appropriately.

The term “fluid” is used here for the flowing media providing the non-stick action, in that this fluid does not have to be a liquid. For example, air bubbles can be utilized in conjunction with water and detergent in the lines, to push concrete material free of the surface 268. In addition to the examples given here, this active non-stick surface system can be used for the “trowel” attachments utilized with robotic placement of concrete or mortar, to smooth the variations in subsequently-placed layers.

For one or more embodiments of the present invention, any of the existing switching-cylinder pumps can be made capable of producing a consistent flow rate of concrete, whether for purposes of reduction of effort and wear by a pump and operator, or to reduce variations in accelerator dosing in shotcrete, or to eliminate vibratory oscillations of boom placement of concrete, or for robotic placement of concrete. As a concrete delivery system, this system allows use of any size aggregate and any available pumping rate, while also allowing robotically-controlled placement of that concrete. Present pumping systems allowing robotically or numerically controlled means of concrete placement, require the use of screw-driven or progressive-cavity types of material pumps, that are generally slow and do not allow use of larger more economical aggregates—or do so at a limited basis and at very higher rates of wear on rubber parts. A fast pumping rate is essential to allow the use of typical plant-batched concrete, in that the concrete delivery truck requires the concrete be discharged in a timely manner, to avoid issues of concrete beginning to harden in the drum and because the batching operation requires job turnover to allow economical operation; one truck can't be tied up on a single job for half a day. For these reasons, the existing pumping systems for additive manufacturing with cementitious materials do not allow the use of conventional concrete or conventional concrete delivery systems, thereby increasing the material costs very significantly and additionally requiring the labor and equipment to mix these materials onsite.

In the foregoing specification, the invention has been described with reference to specific embodiments; however, one of ordinary skill in the art appreciates that various modifications and changes can be made without departing from the scope of the present invention as set forth in the claims below. Accordingly, the specification is to be regarded in an illustrative, rather than a restrictive sense, and all such modifications are intended to be included within the scope of the present invention.

Benefits, other advantages, and solutions to problems have been described above with regard to specific embodiments; however, the benefits, advantages, solutions to problems, and any element(s) that may cause any benefit, advantage, or solution to occur or become more pronounced are not to be construed as a critical, required, or essential feature or element of any or all of the claims.

As used herein, the terms “comprises,” “comprising,” “includes,” “including,” “has,” “having,” “at least one of,” or any other variation thereof, are intended to cover a non-exclusive inclusion. For example, a process, method, article, or apparatus that comprises a list of elements is not necessarily limited only to those elements, but may include other elements not expressly listed or inherent to such process, method, article, or apparatus.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed is:

1. A system that accomplishes pumping a fluid through a pumped line, the pumped line being connected with a piston pump, the system comprising:
a cylinder having a closed end and an aperture toward an opposite end, the cylinder comprising at least one section;
a piston slidably disposed to cyclically move between the closed end and the aperture to move the fluid into and out of the cylinder; and
a controller connected with the piston to control the rate or volume of the fluid moving in and out of the cylinder.

2. The system of claim 1, wherein the controller comprises a spring disposed between the piston and the cylinder to apply force to the piston.

3. The system of claim 1, wherein the controller comprises a spring, a linear damper, a linear actuator, a pneumatic pressure source, a hydraulic pressure source, an electromagnetic linear actuator, or combinations thereof disposed between the piston and the cylinder to apply force to the piston.

4. The system of claim 1, wherein the controller is a passive controller.

5. The system of claim 1, wherein the controller comprises:
an active controller;
an active controller responsive to one or more inputs;
an active controller responsive to one or more measured inputs;
an active controller responsive to one or more inputs from one or more sensors; or
an active controller responsive to one or more inputs and provides one or more control outputs.

6. The system of claim 1, wherein the controller comprises a control means.

7. The system of claim 1, wherein, the pumped line has a sidewall hole, the pumped line connects with the cylinder for the fluid to flow through the aperture and sidewall hole.

8. The system of claim 1, wherein, the pumped line has a sidewall hole, the pumped line connects with the cylinder for the fluid to flow through the aperture and sidewall hole; the angle between the axis of the cylinder and the direction of flow of the fluid at the aperture is greater than 0 degrees and less than 90 degrees.

9. The system of claim 1, wherein, the pumped line has a sidewall hole, the pumped line connects with the cylinder for the fluid to flow through the aperture and sidewall hole; the small angle between the axis of the cylinder and the direction of flow of the fluid at the aperture is greater than 1 degree and less than 89 degrees and all values, ranges, and subranges subsumed therein.

10. The system of claim 1, wherein, the pumped line has a sidewall hole, the pumped line connects with the cylinder for the fluid to flow through the aperture and sidewall hole; the angle between the axis of the cylinder and the direction of flow of the fluid at the aperture is 45 degrees.

11. The system of claim 1, wherein, the pumped line has a sidewall hole, the pumped line connects with the cylinder for the fluid to flow through the aperture and sidewall hole; the angle between the axis of the cylinder and the direction of flow of the fluid at the aperture is greater than 1 degree and less than 89 degrees and all values ranges and subranges subsumed therein; the angle is used to provide a first rate for flow of the fluid into the cylinder and a second rate for the flow of the fluid out of the cylinder, the magnitude of the second rate is greater than the magnitude of first rate.

12. The system of claim 1, further comprising a wye fitting connected for fluid communication between the pumped line and the cylinder; the wye fitting having a geometry that provides a path for the fluid having a higher resistance for the flow of the fluid into the cylinder and a lower resistance for the flow of the fluid out of the cylinder so than the rate of the flow of the fluid into the cylinder is lower than the rate of the flow of the fluid out of the cylinder.

13. The system of claim 1, wherein, dimensions of the cylinder, geometry of the cylinder, or orientation of the cylinder to the pumped line to accomplish a first rate for flow of the fluid into the cylinder and a second rate for the flow of the fluid out of the cylinder, the magnitude of the second rate is greater than the magnitude of first rate.

14. The system of claim 1, wherein the fluid comprises a fluid concrete and the piston pump comprises a concrete pump.

15. The system of claim 1, wherein the cylinder withdraws an amount of the fluid at a first flow rate when the pumped line is at higher pressure and emits the amount of the fluid at a second rate when the pumped line is at lower pressure, the higher pressure and lower pressure are from pressure variations from the piston pump, the second flow rate is higher than the first flow rate so that the flow out of the pumped line is substantially constant.

16. The system of claim 1, wherein the fluid comprises a fluid concrete and the piston pump comprises a concrete pump and further comprises an additive injector connected to provide an additive to the fluid concrete.

17. The system of claim 1, wherein the fluid comprises a fluid concrete and the piston pump comprises a concrete pump and further comprises:
an additive injector connected to provide an additive to the fluid concrete; and
an inline mixer to mix an additive from the additive injector with the fluid concrete.

18. The system of claim 1, wherein the fluid comprises a fluid concrete and the piston pump comprises a concrete pump and further comprises:
an additive injector connected to provide an additive to the fluid concrete;
an inline mixer to mix an additive from the additive injector with the fluid concrete; and
a concrete placement boom connected with the pumped line to direct placement of the fluid concrete.

19. The system of claim 1, wherein the fluid comprises a fluid concrete and the piston pump comprises a concrete pump and the system further comprises:
an additive injector connected to provide an additive to the fluid concrete;
an inline mixer to mix an additive from the additive injector with the fluid concrete;
a concrete placement boom connected with the pumped line to direct placement of the fluid concrete; and
a screeding panel connected with the concrete placement boom to screed a vertical surface of the fluid concrete as the fluid concrete is placed by the pumped line and concrete placement boom.

20. The system of claim 1, wherein the fluid comprises a fluid concrete and the piston pump comprises a concrete pump and the system further comprises:
an additive injector connected to provide an additive to the fluid concrete;
an inline mixer to mix an additive from the additive injector with the fluid concrete;
a concrete placement boom connected with the pumped line to direct placement of the fluid concrete;
a screeding panel connected with the concrete placement boom to screed a vertical surface of the fluid concrete as the fluid concrete is placed by the pumped line and concrete placement boom; and
a vibrator connected with the screeding panel to apply vibration to the fluid concrete.

21. The system of claim 1, wherein the fluid comprises a fluid concrete and the piston pump comprises a concrete pump, the system further comprises:
an additive injector connected to provide an additive to the fluid concrete;
an inline mixer to mix an additive from the additive injector with the fluid concrete;
a concrete placement system connected with the pumped line to direct placement of the fluid concrete to form a vertical or sloped concrete wall, the concrete placement system comprising:
a support structure having two vertical trusses spaced apart an amount;
a translational carriage movably coupled to the support structure to move between the two vertical trusses and connected with the pumped line for controlled two-dimensional positioning placement of the fluid concrete from the pumped line in successive stacked layers to form a concrete wall; and
a vertical slip screed movably coupled to the support structure to vertically screed the fluid concrete to define a surface of the concrete wall.

22. The system of claim 1, further comprising a vibrator connected with the slip screed to apply vibration to the fluid concrete.

23. The system of claim 1, wherein the slip screed has an upper section and lower section vibrationally isolated from the upper section; and further comprising a vibrator connected with the upper section of the slip screed to apply vibration to the fluid concrete.

24. A method of providing a substantially continuous fluid flow from a pumped line feed by a piston pump having high pressure low pressure cyclical fluctuations, the method comprising:
withdrawing an amount of the fluid from the pumped line at a first rate during the high pressure fluctuation; and
emitting the amount of the fluid back to the pumped line at a second rate during the low pressure fluctuation, the second rate being higher than the first rate.

25. The method of claim 24, further comprising controlling the first rate and controlling the second rate.

26. The method of claim 24, further comprising controlling the first rate and controlling the second rate using a passive controller.

27. The method of claim 24, further comprising controlling the first rate and controlling the second rate using an active controller.

28. A method of providing a substantially continuous fluid flow from a pumped line fed by a piston pump having high pressure low pressure cyclical fluctuations, the method comprising:
providing a system according to any of claims 1-23;
withdrawing an amount of the fluid from the pumped line at a first rate during the high pressure fluctuation using the system; and
emitting the amount of the fluid back to the pumped line at a second rate during the low pressure fluctuation using the system, the second rate being higher than the first rate.

29. A device providing a substantially continuous fluid flow from a pumped line feed by a piston pump having high pressure low pressure cyclical fluctuations, the fluid containing a high amount of solids presenting a characteristic of having a high resistance to turns on the pumped line, the device comprising:
means for withdrawing an amount of the fluid from the pumped line at a first rate during the high pressure fluctuation;
means for emitting the amount of the fluid back to the pumped line at a second rate during the low pressure fluctuation, the second rate being higher than the first rate, and
wherein the device has a geometry the reduces the first rate and increases the second rate for the fluid having the characteristic of a high resistance to turns in the pumped line.

30. A system for constructing a plane of concrete that is vertical or sloped, the plane of concrete having an outer face, the system comprising:
a pressurized conduit;
a concrete pump connected to pump a fluid concrete though the pressurized conduit;
a concrete placement device connected with the concrete pump and the pressurized conduit to receive the fluid concrete;
a pair of a linear structural members spanning across a distance of the plane of concrete, each of the linear structural members being at a controlled location; and
a travelling lineal member that spans between each of the pair of linear structural members, the pair of linear structural members providing positional guidance to the traveling linear member;
a defining surface connected with the travelling linear member that determines the outer face of the plane of concrete, the defining surface providing one side of a temporarily confined space for a consolidated placement of the fluid concrete from being moved by the travelling linear member;
wherein a placement of the fluid concrete is made with the placement device between the defining surface and a second surface; and
the travelling linear member being movable incrementally along each linear structural member for repetitive placement of horizontal layers of the fluid concrete to create the plane of concrete.

31. The system of claim 30, wherein the consolidated placement of fluid concrete is assisted by a vibrator.

32. The system of claim 30, wherein each of the pair of the linear structural members can be repositioned a linear guide rail.

33. The system of claim 30, further comprising a second system according to claim 30 wherein the system of claim 30 and the second system according to claim 30 are positioned to form the pane of concrete as a free-standing concrete wall.

34. An automated system for a placement of a fluid concrete into a temporarily confined space, where a continuation of the placement into the space is controlled by a pressure measurement of the fluid concrete within the confined space, where the pressure measurement must reach a predetermined value for the automated system to begin an advance to a new position, so that a consistent volume of the fluid concrete can be dispensed automatically based upon pressure determinations.

35. The system of claim 34, wherein a vibrational consolidation action is imparted to the fluid concrete, and the pressure measurement is utilized to determine when to stop the vibrational consolidation at the confined space.

36. A system for providing a surface of a shaping tool for a cementitious mixture, the surface having a network of pores, where a fluid is provided and controlled though a distribution system, allowing the fluid to be expelled through the network of pores, so that the fluid can create a boundary layer between the surface and the cementitious mixture, and so preventing the cementitious mixture from adhering to the surface.

37. The method of claim 24, further comprising providing a wye fitting having a geometry that provides a difference between the first rate and the second rate, by providing a path for the fluid having more resistance for the first rate and having less resistance for the second rate.

38. A system according to any one of claims 19-23 and 30-35 further comprising:
a surface of a shaping tool for a cementitious mixture, the surface having a network of pores; and
a distribution system to provide and control a fluid expelled through the network of pores, so that the fluid can create a boundary layer between the surface and the cementitious mixture, and so preventing the cementitious mixture from adhering to the surface.

39. The system of claim 30, further comprising a carriage for the concrete placement device, the travelling linear member being connected with the carriage to provide guidance;
